(19) United States
(12) Patent Application Publication
(10) Pub. No.: US 2017/0231032 A1
(43) Pub. Date: Aug. 10, 2017

(54) MANAGEMENT SYSTEM

(71) Applicant: SHARP KABUSHIKI KAISHA, Sakai City, Osaka (JP)

(72) Inventors: Taishi KODAMA, Sakai City, Osaka (JP); Tatsuya MINEOKA, Sakai City, Osaka (JP)

(73) Assignee: Sharp Kabushiki Kaisha, Sakai City, Osaka (JP)

(21) Appl. No.: 15/503,113

(22) PCT Filed: Mar. 25, 2015
(86) PCT No.: PCT/JP2015/059089

§ 371 Date: Feb. 10, 2017

(30) Foreign Application Priority Data
Oct. 23, 2014 (JP) 2014-216303

(51) Int. Cl. H05B 1/02; F24C 5/16; F24C 7/08; F24C 3/12

(52) U.S. Cl. CPC H05B 1/0261; F24C 3/124; F24C 5/16; F24C 7/082

(57) ABSTRACT

A management system includes: a management device; and a terminal device. The management device includes: an acquisition unit that acquires device identification information and usage information, the device identification information identifying a heat cooking appliance, the usage information being obtained according to usage of the heat cooking appliance; and a tabulation unit that tabulates, for each store in which the heat cooking appliance corresponding to the device identification information that has been acquired by the acquisition unit is installed, the usage information having been acquired by the acquisition unit. The terminal device acquires tabulated result tabulated by the tabulation unit, and outputs, to an output, the acquired tabulated result.

### TECHNICAL FIELD

The present invention relates to a management system.

The subject application claims priority based on the patent application No. 2014-216303 filed in Japan on Oct. 23, 2014, and incorporates by reference herein the content thereof.

### BACKGROUND ART

In recent years, a management system that manages a heat cooking appliance installed in a convenience store has been known. In such a management system, there has been one in which, when cooking is done by a heat cooking appliance, the heat cooking is set based on information of the foods and products to be heated (refer to, for example, Patent Document 1).

### PRIOR ART DOCUMENT

### Patent Document

### [Patent Document 1] Japanese Patent Application Publication No. 2013-130305

### SUMMARY OF THE INVENTION

### Problem to Be Solved by the Invention

With the above-described management system, however, although the heat cooking (heating sequence) can be set in accordance with the food or product to be heated, it has been difficult to detect how the heat cooking appliance is being used. For that reason, in the above-described management system, there have been cases, for example, in which efficient heat cooking of food ingredients was not possible, such as when the heat cooking appliance had failed or when the cooking quality of the food ingredient had been reduced.

One aspect of the present invention has been made in consideration of the above-noted situation and has as an object the provision of a management system capable of efficient heat cooking of food ingredients.

### Means for Solving the Problems

One aspect of the present invention is a management system including: a management device that includes: an acquisition unit that acquires device identification information and usage information, the device identification information identifying a heat cooking appliance, the usage information being obtained according to usage of the heat cooking appliance; and a tabulation unit that tabulates, for each store in which the heat cooking appliance corresponding to the device identification information that has been acquired by the acquisition unit is installed, the usage information having been acquired by the acquisition unit; and a terminal device that acquires tabulated result tabulated by the tabulation unit, and outputs, to an output, the acquired tabulated result.

In addition, in one aspect of the present invention, in the management system, the management device may include a shipping processor that, based on the tabulated result tabulated by the tabulation unit, create a shipping proposal for food ingredient to be used in the heat cooking appliance, and the terminal device may acquire the shipping proposal for food ingredient created by the shipping processor and output, to the output, the acquired shipping proposal for food ingredient.

In addition, in one aspect of the present invention, in the management system, the usage information may include usage times and product identification information, the usage times being times at which the heat cooking appliance was used in heat cooking, the product identification information identifying a heat-cooked product, the tabulation unit, based on the usage time and the product identification information, may tabulate a number of times of use of the heat cooking appliance corresponding to the product and a prescribed time of day, for the each store, and the shipping processor, based on the number of times of use of the heat cooking appliance corresponding to the product and the prescribed time of day, may create, for the each store, the shipping proposal for food ingredient corresponding to the product.

In addition, in one aspect of the present invention, the management system may include a store information storage that stores the device identification information and store identification information in association with each other, the store identification information identifying the store in which the heat cooking appliance corresponding to the device identification information is installed, wherein the tabulation unit may read out from the store information storage the store identification information associated with the device identification information acquired by the acquisition unit and, for each store corresponding to the store identification information, tabulate the usage information.

In addition, in one aspect of the present invention, in the management system, the management device may include a change processor that generates a setting key and a setting change instruction, the setting key being settable to heat cooking corresponding to a product to be heat-cooked in the heat cooking appliance, the setting change instruction changing the setting of heat cooking corresponding to the setting key, the generation being performed in accordance with a change of the product, and the heat cooking appliance, based on the setting change instruction generated by the change processor, may change the setting of heat cooking corresponding to the setting key.

In addition, in one aspect of the present invention, the management system may include a food ingredient proposal unit that, based on the tabulated result tabulated by the tabulation unit, proposes food ingredient to be heat-cooked by the heat cooking appliance.

In addition, in one aspect of the present invention, in the management system, the food ingredient proposal unit, based on the tabulated result, may propose a half-cooked item that becomes a finished item by heat cooking by the heat cooking appliance.

In addition, in one aspect of the present invention, in the management system, the food ingredient proposal unit, based on the tabulated result, may propose food ingredient of a half-cooked item in accordance with the heat cooking setting set at a setting key to which heat cooking setting can be set in the heat cooking appliance.

### Effect of the Invention

According to one aspect of the present invention, efficient heat cooking of food ingredients is possible.

### BRIEF DESCRIPTION OF THE DRAWINGS

FIG. 1 is a drawing generally describing a management system according to the present invention.

FIG. 2 is a functional block diagram showing an example of a management system according to a first embodiment.

FIG. 3 shows an example of data in a usage information storage in the first embodiment.

FIG. 4 shows an example of data in a store setting storage in the first embodiment.

FIG. 5 shows an example of data in a store information storage in the first embodiment.

FIG. 6 shows an example of data in a tabulated information storage in the first embodiment.

FIG. 7 shows an example of shipping schedule proposal processing in the first embodiment.

FIG. 8 is an outer view showing an example of a heat cooking appliance in the first embodiment.

FIG. 9 is a functional block diagram showing an example of a heat cooking appliance in the first embodiment.

FIG. 10 shows an example of data of a setting information storage in the first embodiment.

FIG. 11 is a flowchart showing an example of feedback processing of usage information by a management system of the first embodiment.

FIG. 12 is a flowchart showing an example of setting change processing of a heat cooking appliance by a management system of the first embodiment.

FIG. 13 is a functional block diagram showing an example of a management system according to a second embodiment.

FIG. 14 shows an example of data in usage information storage in the second embodiment.

FIG. 15 is a flowchart showing an example of the feedback processing of usage information by a management system of the second embodiment.

FIG. 16 is a functional block diagram showing an example of a management system according to a third embodiment.

FIG. 17 is a flowchart showing an example of the usage information feedback processing by a management system of the third embodiment.

### EMBODIMENTS FOR CARRYING OUT THE INVENTION

Management systems according to embodiments of the present invention are described below, with references made to the drawings.

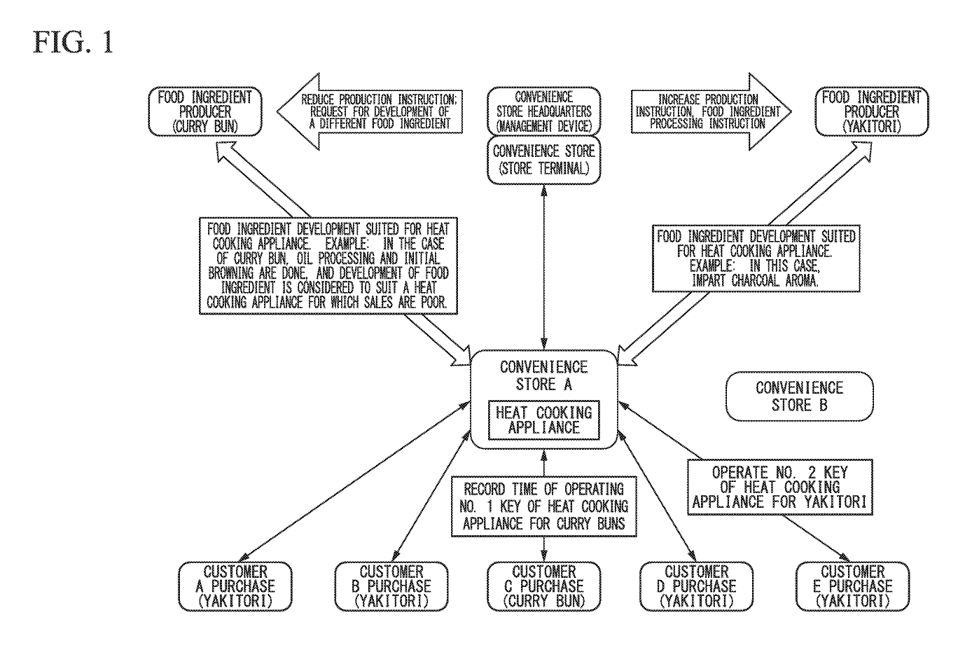

Before describing the various embodiments of the present invention in detail, the present invention will be generally described, referring to FIG. 1.

FIG. 1 generally describes the management system according to the present invention.

As shown in the FIG. 1, in the management system according to the present invention, a heat cooking appliance installed in a convenience store records usage information obtained when the heat cooking appliance is used when customers A, B, C, D, and E purchase yakitori or curry buns in a convenience store (such as “convenience store A”). The heat cooking appliance has cooking keys that can set cooking menu items and, for example, records the time when a cooking key 1 (curry bun) is operated.

The convenience store headquarters (management device), for example, distributes an instruction for a change of menu for convenience store A via a store terminal. The distributed change of menu instruction is written into the heat cooking appliance from a USB (Universal Serial Bus) memory, and the settings of the cooking keys are changed. When a setting change is to be made, the heat cooking appliance, for example, writes to the USB memory the records of cooking keys and times of operation as usage information, and this usage information is transmitted to the convenience store headquarters (management device) via the store terminal.

In the management system according to the present embodiment, the following feedback (utilization) processing is done, based on this usage information.

(Processing 1) The convenience store headquarters (management device), based on usage information acquired from the heat cooking appliance, feeds back (utilizes) to an instruction to increase/decrease of food ingredient production or the shipping of cooking food ingredients (for example, ingredients of curry buns, yakitori and the like).

(Processing 2) The convenience store headquarters (management device), based on the usage information acquired from the heat cooking appliance, feeds back (utilizes) to maintenance instructions such as changing the allocation of cooking keys to prevent deterioration of the cooking keys.

(Processing 3) The convenience store headquarters (management device), based on the usage information acquired from the heat cooking appliance, feeds back (utilizes) to the sending of cooking food ingredient proposals to a food ingredient producer for curry buns or yakitori, such as a request for development of cooking food ingredient or processing instructions to develop and improve cooking food ingredients. That is, the food ingredient producer develops and improves cooking food ingredients in accordance with the heat cooking of the heat cooking appliance.

### First Embodiment

Next, a management system according to the first embodiment will be described.

In the present embodiment, the above-described (Processing 1) will be described in detail.

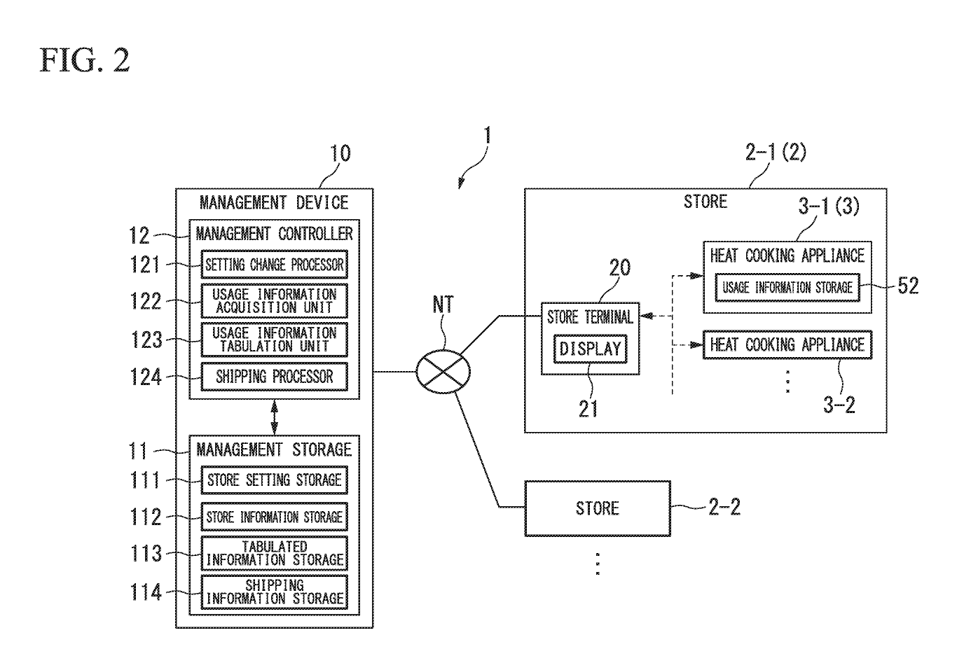

FIG. 2 is a functional block diagram showing an example of a management system 1 according to the present embodiment.

The management system 1 has a management device 10, and the store terminal 20 and heat cooking appliances (3-1, 3-2, . . . ) of each of the stores (2-1, 2-2, . . . ).

In this case, the stores (2-1, 2-2, . . . ) have the same constitution regarding the store terminal 20 and the heat cooking appliances (3-1, 3-2, . . . ), and when an arbitrary store of the management system 1 is indicated or when no distinction is particularly made, this will be described as store 2.

The heat cooking appliances (3-1, 3-2, . . . ) are the same with regard to having the usage information storage 52, and when an arbitrary heat cooking appliance of the store 2 is indicated or when no distinction is particularly made, this will be described as the heat cooking appliance 3.

In the present embodiment, the management device 10 and the store terminal 20 of each store 2 are connected via a network NT.

A store 2, for example, is a convenience store or the like, and has a store terminal 20 and a plurality of heat cooking appliances 3. In a store 2, for example, a store employee does heat cooking of a cooking food ingredient of a product using a heat cooking appliance 3 and sells the heat-cooked product to a customer.

The store terminal 20 (an example of a terminal device) is, for example, a personal computer that has a communication function and is connected to the management device 10 via the network NT. The store terminal 20 can be connected to a USB memory. The store terminal 20 for example, receives a setting change instruction for the heat cooking appliance 3 transmitted from the management device 10, and stores the received setting change instruction into the USB memory. The store terminal 20 is connected to a USB memory that stores usage information collected from the heat cooking appliance 3, acquires usage information from the USB memory, and transmits usage information to the management device 10. In this case, the usage information is, for example, is acquired in accordance with use of the heat cooking appliance 3, the details of which are described later.

The store terminal 20 has a display 21 (an example of an output), and outputs to the display 21 various information acquired from the management device 10. The store terminal 20, for example, acquires from the management device 10 and displays on the display 21 tabulation results of tabulating the usage information, which will be described later, a food ingredient shipping proposal, and maintenance information of the heat cooking appliance 3 and the like.

The heat cooking appliance 3, for example, is a cooker that can do cooking of a plurality of types by heat, such as a microwave oven that heats using microwaves, an oven/grill that heats by hot air, radiated heat, or heating by heat conduction from a tray based on an electric heater, or a water oven or water grill that heats by super-heated steam. In the heat cooking appliance 3, for example, cooking keys are set in correspondence to various products to be cooked by heating and, by pressing cooking keys, heat cooking of the corresponding products is executed. The heat cooking appliance 3 has a usage information storage 52. Details of the constitution of the heat cooking appliance 3 will be described later.

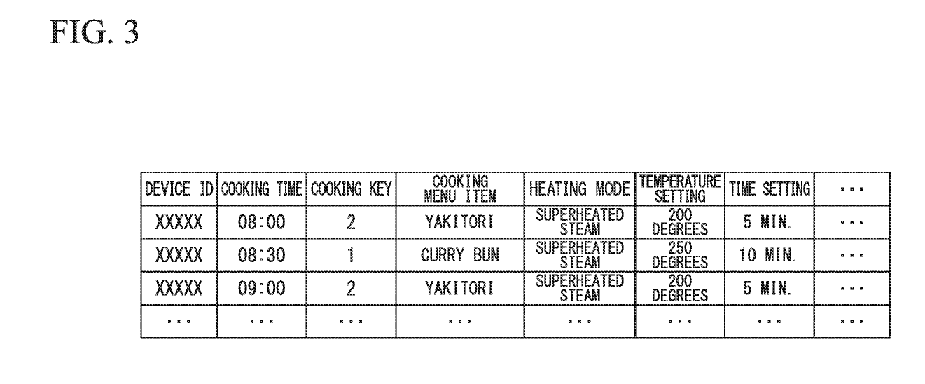

The usage information storage 52 stores usage information obtained in accordance with use of the heat cooking appliance 3. The usage information storage 52 stores device identification information that identifies the heat cooking appliance 3 and usage information, in association with each other. The usage information storage 52, for example as shown in FIG. 3, stores the device ID, the cooking time, the cooking key, the cooking menu item, the heating mode, the temperature setting, and the time setting, in association with each other.

FIG. 3 shows an example of the data in the usage information storage 52 in the present embodiment.

In this case, the device ID is an example of the device identification information noted above, and the cooking time, the cooking key, the cooking menu item, the heating mode, the temperature setting, and the time setting are examples of usage information. The cooking time indicates the time that the heat cooking appliance 3 has been used, and the cooking key indicates the number of the cooking key that was used. The cooking menu item indicates the product that was cooked, and the heating mode indicates the type of heat cooking. The temperature setting and the time setting indicate the temperature and time that were set by the cooking key that was used.

For example, in the example shown in FIG. 3, the cooking menu item yakitori was cooked by the heat cooking appliance 3 with the device ID XXXXX, at the cooking time of 08:00 and using the cooking key 2. Also indicated is that the yakitori was cooked by heating for the time setting of 5 minutes at the temperature setting of 200 degrees, and with the heating mode of superheated steam, which are allocated to the cooking key 2.

In the case of the heating mode, the usage information storage 52 may store, instead of temperature setting, the microwave output (for example, 600 W (watts)) or the like.

Each time it is used, the heat cooking appliance 3 stores its own device ID, in association with the above-described usage information into the usage information storage 52. When a setting change of the cooking keys is made by a USB memory, the information stored in the usage information storage 52, for example, is stored in the USB memory, and the store terminal 20 transmits the device ID and the above-described usage information stored in the USB memory to the management device 10, via the network NT.

Returning to the description of FIG. 2, the management device 10, for example, is a computer of the convenience store headquarters that controls all the stores 2 and has a communication function. The management device 10, for example, has a management storage 11 and a management controller 12.

The management storage 11 stores various information used when the management device 10 executes various processing. The management storage 11 has, for example, a store setting storage 111, a store information storage 112, a tabulated information storage 113, and a shipping information storage 114.

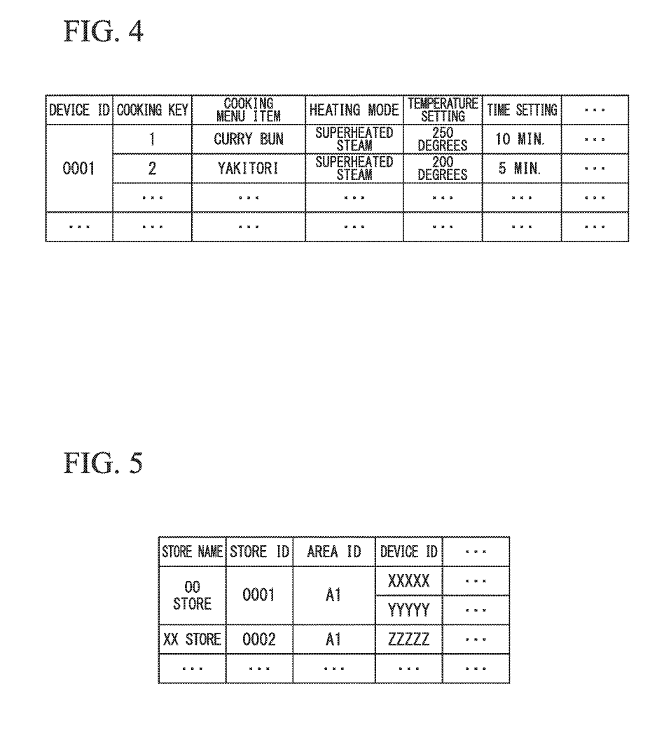

The store setting storage 111 stores information regarding the cooking keys of the heat cooking appliance 3 installed in the stores 2 managed by the management device 10. The store setting storage 111 stores, for example, store identification information that identifies the stores 2 and setting information regarding the cooking keys, in association with each other. Specifically, the store setting storage 111, as shown in FIG. 4, stores the store ID, the cooking key, the cooking menu item, the heating mode, the temperature setting, and the time setting, in association with each other.

FIG. 4 shows an example of the data in the store setting storage 111 in the present embodiment.

In this case, the store ID shows the store identification information and the cooking key, cooking menu item, heating mode, temperature setting, and time setting are the same as in the above-described FIG. 3.

In the example shown in FIG. 4, the cooking key 1 of the store 2 having the store ID of 0001 corresponds to curry bun, and the heat cooking settings of heating mode, temperature setting, and time setting thereof are, respectively superheated steam, 250 degrees, and 10 minutes. The cooking key 2 of the store 2 having the store ID of 0001 corresponds to yakitori, and the heat cooking settings of heating mode, temperature setting, and time setting thereof are, respectively superheated steam, 200 degrees, and 5 minutes.

The store setting storage 111 is taken to have stored information regarding the cooking keys of the heat cooking appliance 3 such as shown in FIG. 4 beforehand.

Returning to the description of FIG. 2, the store information storage 112 stores store information regarding the stores 2 managed by the management device 10. The store information storage 112 stores, for example, the store name, the store ID, the area ID, and the device ID.

FIG. 5 shows an example of the data in the store information storage 112 in the present embodiment.

In this case, the store name indicates the name of the store 2, and the area ID indicates identification information identifying the area (region) where the store 2 is located. A device ID indicated here indicates the device ID of a heat cooking appliance 3 installed in the store 2 corresponding to the store name and the store ID. In this manner, the store information storage 112 stores the device ID and the store identification information identifying the store 2 in which the heat cooking appliance 3 corresponding to the device ID is installed, in association with each other. The store name and the store ID are examples of store identification information identifying the store 2.

In the example shown in FIG. 5, the store ID of the store name store OO is 0001, and the area ID thereof is A1. Also, the device IDs of the heat cooking appliances 3 installed in store OO are shown as XXXXX and YYYYY.

The store information storage 112 is taken to have stored information such as shown in FIG. 5 beforehand.

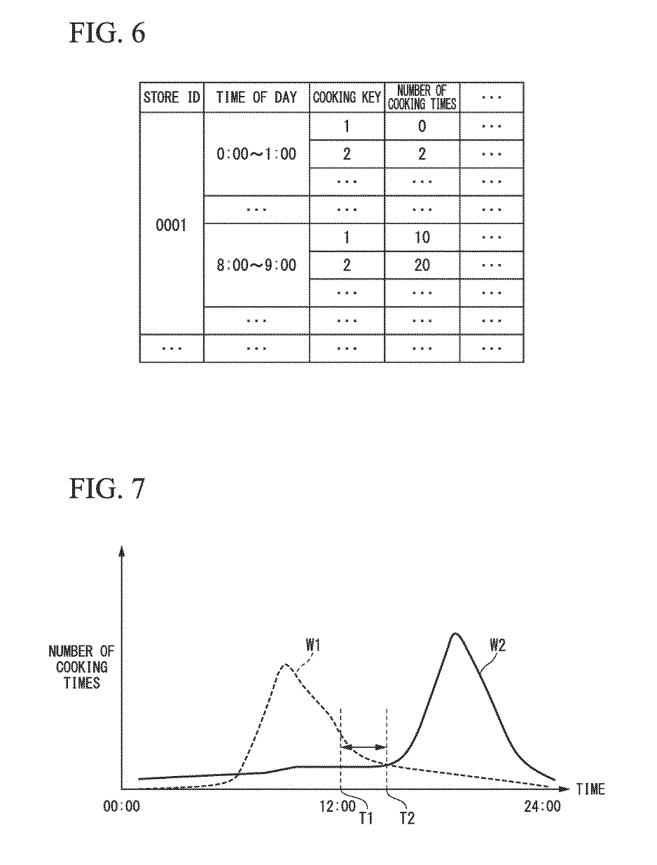

Returning to the description of FIG. 2, the tabulated information storage 113 stores information indicating the results of tabulating usage information stored by the heat cooking appliance 3. The tabulation results in this case are, for example, the results of tabulating, for each store 2, the number of times that the heat cooking appliance 3 is used corresponding to products and prescribed times of day. The tabulated information storage 113 stores, for example as shown in FIG. 6, the store ID, the time of day, the cooking key, and the number of times of cooking, in association with each other.

FIG. 6 shows an example of the data in the tabulated information storage 113 in the present embodiment.

Here, the time of day indicates the time of day the heat cooking appliance 3 is used, and the cooking key and number of times of cooking indicate the cooking key and number of times they are used at that time of day.

In the example shown in FIG. 6, in the store 2 corresponding to the store ID of 0001, the cooking key 1 is used 0 times and the cooking key 2 is used 2 times at a time of day from 0:00 to 1:00. Also, in the store 2, the cooking key 1 is used 10 times and the cooking key 2 is used 20 times at a time of day from 8:00 to 9:00. The information indicating the tabulation results stored by the tabulated information storage 113 are stored by the usage information tabulation unit 123, to be described later.

Returning to the description of FIG. 2, the shipping information storage 114 stores shipping proposals for cooking food ingredients corresponding to each product for which the heat cooking appliance 3 is used. A cooking food ingredient shipping proposal is created by the shipping processor 124, to be described later, and is stored in the shipping information storage 114. The shipping information storage 114 stores, for example, a shipping proposal of appropriate times and appropriate quantities of shipments to each store 2 for the cooking and sale of each product using the heat cooking appliance 3.

The management controller 12, for example, is a processor that includes a CPU (central processing unit) and performs overall control of the management device 10. The management controller 12 has, for example, a setting change processor 121, a usage information acquisition unit 122, a usage information tabulation unit 123, and a shipping processor 124.

The setting change processor 121 (an example of a change processor), generates a setting change instruction that changes the settings of heat cooking corresponding to cooking keys in response to a product change. That is, the setting change processing 121, for example, if there is an instruction to change a product from the convenience store headquarters, generates a setting change instruction that changes the cooking key allocations and the heat cooking settings. The setting change instruction includes, for example, the cooking key, the cooking menu item, the heating mode, the temperature setting, and the time setting to be changed. The setting change processor 121, in accordance with the change of the cooking key allocations and heat cooking settings, changes the information regarding the cooking keys of the heat cooking appliances 3 of each store 2 stored in the store setting storage 111. The setting change processor 121 transmits the generated setting change instruction to the store terminal 20 of each store 2 at which the product is changed.

The product change may be made for each store 2 individually or for each area (region) individually in which stores 2 exist, and the setting change processor 121 transmits a setting change instruction corresponding to the stores 2 at which the product change is made to the store terminal 20 of each of the stores 2 in which a change is to be made.

In response, the store terminal 20 of each of the stores at which a change is to be made stores the received setting change instruction into a USB memory and, based on the setting change instruction stored in USB memory, the heat cooking appliance 3 executes the change of the cooking key allocations and heat cooking settings. For example, when the cooking key allocations and heat cooking settings are changed, the heat cooking appliance 3 stores the device ID and usage information stored in the usage information storage 52 into the USB memory. The heat cooking appliance 3 may store into the USB memory the device ID and the usage information stored by the usage information storage 52 when the USB memory is periodically connected to the heat cooking appliance 3.

The usage information acquisition unit 122 (an example of an acquisition unit) acquires the device ID that identifies the heat cooking appliance 3 and the usage information obtained according to usage of the heat cooking appliance 3. The usage information acquisition unit 122, for example, acquires the device ID and the usage information from the store terminal 20 to which the above-described USB memory is connected. The usage information includes, for example, the time of use of the heat cooking appliance 3 for heat cooking and product identification information identifying the product that was cooked by heating. In the specification information shown in FIG. 4, the cooking key and the cooking menu item correspond to product identification information.

The usage information tabulation unit 123 (an example of a tabulation unit), for each store 2 in which a heat cooking appliance 3 corresponding to a device ID acquired by the usage information acquisition unit 122, tabulates the usage information acquired by the usage information acquisition unit 122. The usage information acquisition unit 123, for example, based on the usage time and the product identification information, tabulates, for each store 2, the number of times the heat cooking appliance 3 corresponding to the products and prescribed times of day. In this case, for example, the usage information tabulation unit 123 reads out from the store information storage 112 the store IDs associated with the device IDs acquired by the usage information acquisition unit 122, and tabulates the usage information for each store 2 corresponding to a store ID. As shown in FIG. 6, the usage information tabulation unit 123 stores the tabulated results in the tabulated information storage 113. The usage information tabulation unit 123, for example, in response to a request from the store terminal 20 of each store 2, transmits the tabulated results to the store terminal 20, in which case the store terminal 20, for example, acquires the tabulated results tabulated by the usage information tabulation unit 123 and outputs the acquired tabulated results to the display 21.

The shipping processor 124, based on the tabulated results tabulated by the usage information tabulation unit 123, creates a shipping proposal for food ingredients used in the heat cooking appliance 3. The shipping processor 124, for example, based on the product and the number of times the heat cooking appliance 3 corresponding to the prescribed time of day, creates a food ingredient shipping proposal corresponding to the products for each store 2. The shipping processor 124, for example, does a back calculation from the time of day in which the heat cooking appliance 3 is used many times for a product and creates a shipping schedule (shipping proposal) to ship food ingredient corresponding to the product, so that cooking is sufficient in the time of day when the number of times of usage is large. The shipping processor 124, for example, based on the number of times of usage of the heat cooking appliance 3 for each product, create a shipping proposal that increases or decreases the quantity of the food ingredient that is shipped.

FIG. 7 shows an example of the shipping schedule proposal processing in the present embodiment.

FIG. 7 is a graph of the tabulated results tabulated by the usage information tabulation unit 123, in which the vertical axis represents number of cooking times (number of usage times), and the horizontal axis represents time. The curve W1 for example, indicates the number of cooking times for the cooking key 1, and the curve W2 indicates the number of cooking times for the cooking key 2. In this case, the cooking keys are used as product identification information that identifies the products.

For example, a product corresponding to the cooking key 2 of the curve W2 tends to have an increase in the number of cooking times from around the time T2. That is, the product corresponding to the cooking key 2 can be estimated to be a product that starts to sell around the time T2. At the time T1, the shipping processor 124 creates a shipping schedule by which the food ingredient for the product corresponding to the cooking key 2 arrives that takes into account the cooking time, so that the increase in the number of cooking times from time T2 is accommodated. The shipping processor 124, for example, based on the accumulated number of cooking times in one day for each product, estimates the food ingredient quantity used in one day, and creates a shipping proposal to increase and decrease the food ingredient quantity in accordance with each product. For example, because the product corresponding to the cooking key 2, compared to the product corresponding to the cooking key 1 of the curve W1 has more accumulated cooking times in one day, a shipping proposal is created by which more food ingredient is shipped than the product corresponding to the cooking key 1.

The shipping processor 124 stores the created shipping proposal into the shipping information storage 114. The shipping processor 124, for example, in response to a request from the store terminal 20 of each store 2, transmits a created shipping proposal to the store terminal 20. In this case, the store terminal 20 acquires the food ingredient shipping proposal created by the shipping processor 124 and outputs the acquired food ingredient shipping proposal to the display 21.

Next, the detailed constitution of the heat cooking appliance 3 according to the present embodiment will be described.

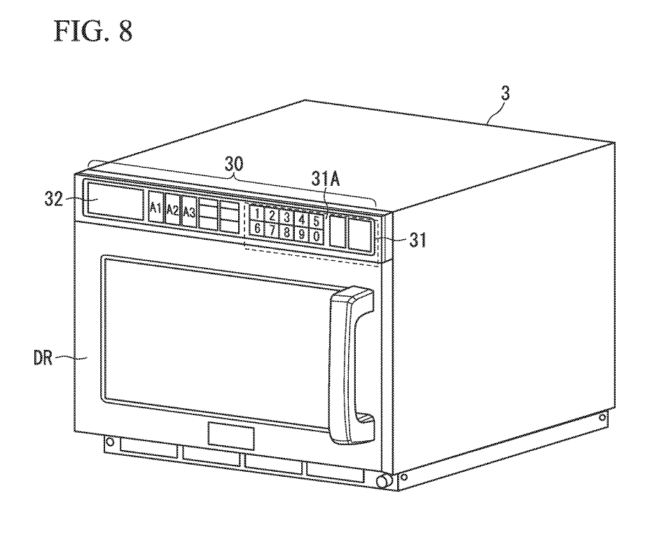

FIG. 8 shows the outer appearance of an example of the heat cooking appliance 3 according to the present embodiment.

The heat cooking appliance 3 has an outer appearance that is substantially a rectangular parallelepiped, with a door DR swingably mounted to an aperture that occupies the major part of the front surface thereof. The heat cooking appliance 3 has an operating panel 30 on the upper part of the front surface.

The operating panel 30 is for making various operations of the heat cooking appliance 3 and has, for example, a key input section 31 and liquid crystal display 32.

The key input section 31 has, for example, a plurality of operating keys and accepts various operations by the user. The key input section 31 has, for example, a plurality of cooking keys 31A (examples of setting keys) to which are allocated heat cooking settings corresponding to each product to be cooked by heat. In this case, the cooking keys 31A have settings for heat cooking corresponding to products that are cooked with heat, with 1 being curry buns and 2 being yakitori.

The liquid crystal display 32 is the output that outputs information to the user and is, for example, a liquid crystal display device. The liquid crystal display 32 displays various information when various operations of the heat cooking appliance 3 are made. For example, when a cooking key 31A is pressed, the liquid crystal display 32 displays information regarding the heat cooking allocated to the cooking key 31A. This information regarding heat cooking is information indicating implements for heat cooking (for example, water required, steel plate required, and mesh required), and information indicating implements that are prohibited to use in the heat cooking.

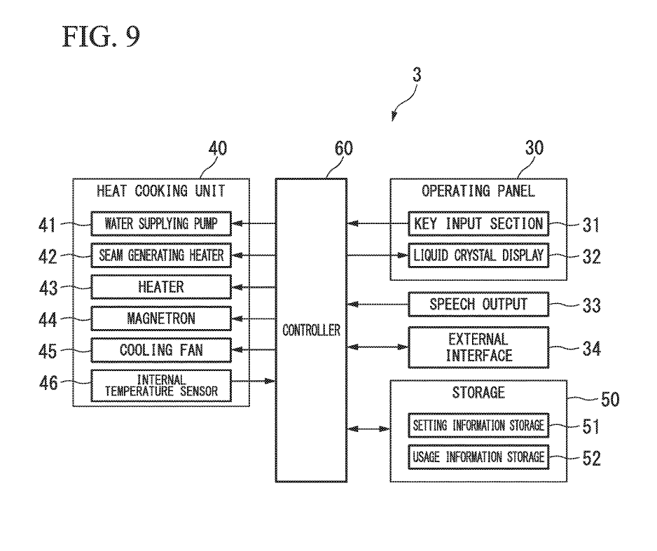

FIG. 9 is a functional block diagram showing an example of the heat cooking appliance 3 according to the present embodiment.

As shown in the FIG. 9, the heat cooking appliance 3 has an operating panel 30, a speech output 33, an external interface 34, a heat cooking unit 40, a storage 50, and a controller 60.

The speech output 33 is, for example, a speaker, and is an output that outputs information to the user simultaneously with the liquid crystal display 32. The speech output 33, for example, outputs to the user, in the form of speech, information indicating various guidance, cautions, warnings, and the like in operating the heat cooking appliance 3. When a cooking key 31A is pressed, the speech output 33, for example, notifies of the cooking menu item or heat cooking settings allocated to the cooking key 31A, using a voice. This enables a reduction of errors in operating the cooking keys 31A.

The external interface 34 performs receiving and transmitting of information between the heat cooking appliance 3 and the outside. The external interface 34 is, for example, a USB interface, and is used to pass information with a USB memory.

The heat cooking unit 40 executes heat cooking of food ingredients and the like. The heat cooking appliance 3 in the present embodiment can do cooking of a plurality of types by heat, such as a microwave oven that heats using microwaves, an oven grill that heats by hot air, radiated heat, or heating by heat conduction from a tray based on an electric heater, or a water oven or water grill that heats by super-heated steam.

The heat cooking unit 40 has a water supplying pump 41, a steam generating heater 42, a heater 43, a magnetron 44, a cooling fan 45, and an internal temperature sensor 46.

The water supplying pump 41 supplies water in a water supply tank (not shown) to the steam generating heater 42.

The steam generating heater 42 (an example of an electric heater) heats water supplied from the water supplying pump 41 and generates steam. That is, the steam generating heater 42 generates steam when heat cooking is done using the above-noted superheated steam.

The heater 43 (and example of an electric heater), for example, when heat cooking by superheated steam, superheats the steam generated by the steam generating heater 42 to generate superheated steam. In this case, superheated steam is steam that is heated to the superheated state of greater than 100° C. The heater 43, for example, generates heat when heat cooking by an oven or a grill, and heats the item to be heated (for example, food ingredients) by hot air, radiated heat, or conducted heat from a tray.

The magnetron 44 generates microwaves when heat cooking by a microwave oven.

The cooling fan 45 cools electrical devices such as the water supplying fan 41.

The internal temperature sensor 46 detects the air temperature inside the heating chamber (not shown) that heats the food ingredient.

The storage 50 stores various information used when the heat cooking appliance 3 is operated. The storage 50 has, for example, a setting information storage 51 and a usage information storage 52.

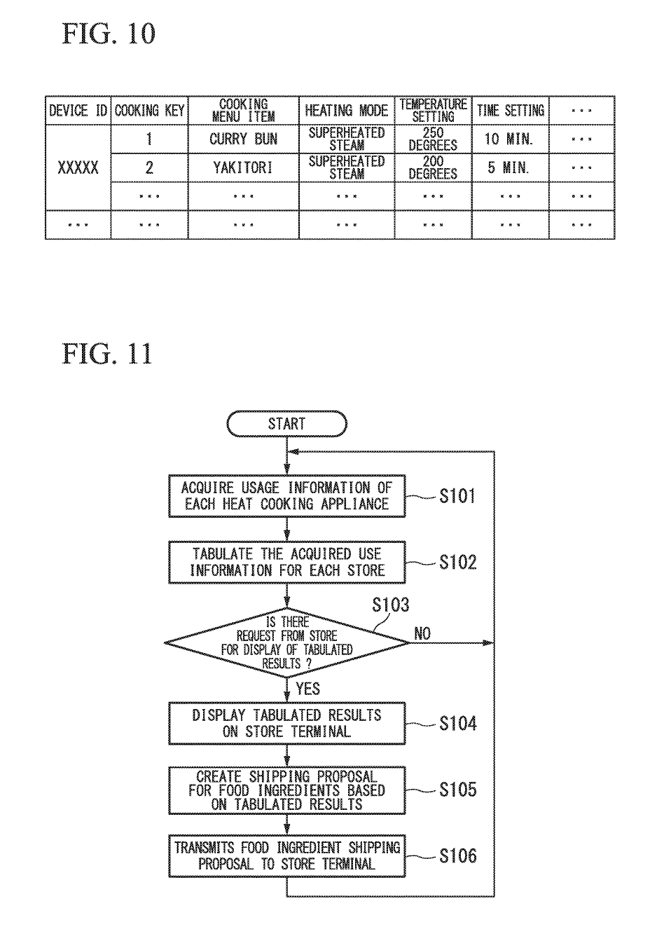

The setting information storage 51 stores setting information regarding the allocations of the cooking keys 31A. That is, the setting information storage 51 stores the cooking keys 31A and the heat cooking setting corresponding to the cooking keys 31A, in association with each other. The setting information storage 51, for example as shown in FIG. 10, stores the device ID, the cooking key, the cooking menu item, the heating mode, the temperature setting, and the time setting, in association with each other.

FIG. 10 shows an example of the data in the setting information storage 51 in the present embodiment.

In the example shown in the drawing, in the heat cooking appliance 3 having the device ID of XXXXX, the cooking key 1 is set to curry buns and 2 is set to yakitori.

The heat cooking appliance 3, based on a setting change instruction generated by the setting change processor 121, changes the settings of the heat cooking corresponding to the cooking keys 31A. That is, the heat cooking appliance 3, based on the setting change instruction, changes the settings of heat cooking stored by the setting information storage 51 (for example, the cooking key, cooking menu item, heating mode, temperature setting, and time setting).

Because the usage information storage 52 has been described above with reference to the above-described FIG. 3, the description thereof will be omitted here.

Returning to the description of FIG. 9, the controller 60, for example, is a processor that includes a CPU or the like and performs overall control of the heat cooking appliance 3. The controller 60, for example, based on a setting change instruction acquired from a USB memory via the external interface 34, changes the heat cooking settings stored in the setting information storage 51. The controller 60, for example, stores the device IDs and the usage information stored in the usage information storage 52 into the USB memory via the external interface 34. The controller 60 acquires from the setting information storage 51 heat cooking settings in accordance with the cooking keys 31A and, based on the acquired heat cooking settings, operates the heat cooking unit 40. Each time heat cooking is executed, the controller 60 stores the device ID, the cooking time, the cooking key, the cooking menu item, the heating mode, the temperature setting, and the time setting into the usage information storage 52, in association with each other.

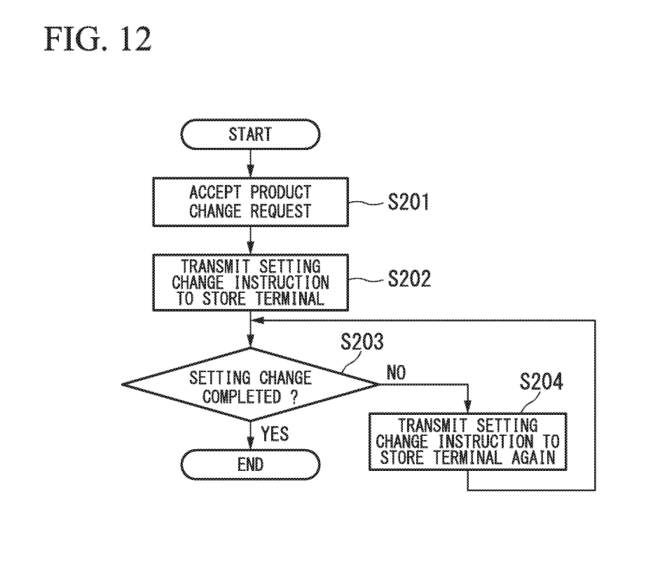

Next, the operation of the management system 1 according to the present embodiment will be described, with references made to FIG. 11 and FIG. 12.

FIG. 11 is a flowchart showing an example of the feedback processing of usage information by the management system 1 of the present embodiment.

In the present embodiment, the management system 1 is described for the example of a case in which the usage information is fed back to the food ingredient shipping.

As shown in FIG. 11, the usage information acquisition unit 122 of the management device 10 acquires the usage information of each heat cooking appliance 3 (step S101). That is, the usage information acquisition unit 122 acquires the device IDs and the usage information of each heat cooking appliance 3 from the store terminal 20, via a USB memory.

Next, the usage information tabulation unit 123 tabulates the acquired specification information for each store 2 (step S102). The usage information tabulation unit 123, for example, reads out from the store information storage 112 store IDs associated with device IDs acquired by the usage information acquisition unit 122 and tabulates the usage information for each of the stores 2 associated with the store IDs. That is, the usage information tabulation unit 123, for each store 2, tabulates the number of usages of the heat cooking appliances 3 that correspond to products and prescribed times of the day. The usage information tabulation unit 123, as shown in FIG. 6, stores the tabulated results, which had been tabulated, into the tabulated information storage 113.

Next, the usage information tabulation unit 123 determines whether or not there is a request from a store 2 for the display of tabulated results (step S103). That is, the usage information tabulation unit 123 determines whether or not there is a request from the store terminal 20 of a store 2 to transmit the tabulated results that have been tabulated by the usage information tabulation unit 123. If there is a request for transmission (request for display) of the tabulated result (YES at step S103), the usage information tabulation unit 123 proceeds to the processing of step S104. If there is no request for transmission (request for display) of the tabulated results (NO at step S103), the usage information tabulation unit 123 returns to the processing of step S101.

At step S104, the usage information tabulation unit 123 displays the tabulated results on the store terminal 20. That is, the usage information tabulation unit 123, in response to a tabulated result transmission request, for example, sends the tabulated results stored in the tabulated information storage 113 to the store terminal 20 and displays them on the display 21 of the store terminal 20. The store terminal 20 may, for example, display on the display 21 a graph such as shown in FIG. 7. Because this presents the tabulated results tabulated by the usage information tabulation unit 123 to a store employee of a store 2, it can be used as a reference in, for example, ordering food ingredients.

Next, the shipping processor 124, based on the tabulated result tabulated by the usage information tabulation unit 123, creates a shipping proposal for food ingredients used in the heat cooking appliance 3 (step S105). The shipping processor 124, for example, based on the number of times the heat cooking appliance 3 is used for a product and the prescribed time of day, creates a shipping proposal for food ingredients for the product for each store 2. The shipping processor 124, for example, does a back calculation from the time of day in which the heat cooking appliance 3 is used many times for a product and creates a shipping schedule (shipping proposal) to ship food ingredient corresponding to the product, so that cooking is sufficient in the time of day when the number of times of usage is large. The shipping processor 124, based on the number of times of usage of the heat cooking appliance 3 for each product, create a shipping proposal that increases or decreases the quantity of the food ingredient to be shipped. The shipping processor 124 stores the created shipping proposal into the shipping information storage 114.

Next, the shipping processor 124 transmits the created food ingredient shipping proposal to the store terminal 20 (step S106). The store terminal 20 acquires the food ingredient shipping proposal and outputs the acquired food ingredient shipping proposal to the display 21. By doing this, an employee of a store 2 can use the food ingredient shipping proposal created by the management device 10 as a reference and can order food ingredients and request shipping with good efficiency. After the processing of step S106, the shipping processor 124 returns to the processing to step S101.

Next, the operation in heat cooking appliance 3 setting change processing by the management system 1 will be described, with reference made to FIG. 12.

FIG. 12 is a flowchart showing an example of the setting change processing of the heat cooking appliance 3 by the management system 1 of the present embodiment.

As shown in the FIG. 12, if the heat cooking appliance 3 setting change processing is to be performed, the management device 10 first accepts a product change request (step S201). That is, the setting change processor 121 of the management device 10, for example, accepts a product change request (cooking menu item change request) from the convenience store headquarters.

Next, the setting change processor 121 transmits a setting change instruction to the store terminal 20 (step S202). The setting change processor 121, for example, in response to a request to change the setting of products, generates a setting change instruction that changes the cooking key allocations and the heat cooking settings. The setting change processor 121, in accordance with the change of the cooking key allocations and heat cooking settings, changes information regarding the cooking keys of the heat cooking appliances 3 of each store 2 that is stored in the store setting storage 111. The setting change processor 121 transmits the generated setting change instruction to the store terminals 20 of the stores 2 at which the product change is to be made.

In this case, the setting change instruction that is transmitted to the store terminal 20 is distributed to each heat cooking appliance 3 via a USB memory, and the setting change of each heat cooking appliance 3 is executed. Usage information of each heat cooking appliance 3 is stored in the USB memory, and the store terminal 20 reads out the usage information of each heat cooking appliance 3 from the USB memory and transmits to the management device 10 information indicating that the setting changes of each heat cooking appliance 3 has been completed. When the heat cooking appliance 3 setting change has been executed, the controller 60 of the heat cooking appliance 3 may make a notification to the effect that a setting change has been executed, by speech from the speech output 33. After a heat cooking appliance 3 setting change is executed, when using the heat cooking appliance 3, the controller 60 may make a notification to the effect that a setting change has been executed, by speech from the speech output 33.

Next, the setting change processor 121 determines whether or not the setting change has been completed (step S203). That is, by whether or not information has been received from the store terminal 20 indicating that the setting changes in each heat cooking appliance 3 has been completed, the setting change processor 121 determines whether or not the setting change has been completed. If the setting change has been completed (YES at step S203), the setting change processor 121 ends the processing. If the setting change has not been completed (NO at step S203), the setting change processor 121 proceeds to the processing of step S204.

At step S204, the setting change processor 121 again transmits to the store terminal 20 a setting change instruction. After the processing of step S204, the setting change processor 121 returns to the processing of step S203.

As described above, the management system 1 according to the present embodiment has a management device 10 that has a usage information acquisition unit 122 (acquisition unit), and a usage information tabulation unit 123 (tabulation unit) and a store terminal 20 (terminal device). The usage information acquisition unit 122 acquires a device ID (device identification information) that identifies a heat cooking appliance 3 and usage information that is obtained in accordance with use of the heat cooking appliance 3. The usage information tabulation unit 123, for each store 2 in which a heat cooking appliance 3 corresponding to a device ID acquired by the usage information acquisition unit 122 is installed, tabulates the usage information acquired by the usage information acquisition unit 122. The store terminal 20 then acquires the tabulated results tabulated by the usage information tabulation unit 123 and outputs the acquired tabulated results to the display 21 (output).

Because this enables an employee of the store 2 to refer to the tabulated results of the usage information of the heat cooking appliance 3 in, for example, making appropriate food ingredient orders and shipping, the management system 1 according to the present embodiment enables efficient heat cooking of food ingredients (cooking food ingredients).

In the present embodiment, the management device 10, has a shipping processor 124 that, based on the tabulated results tabulated by the usage information tabulation unit 123, creates a shipping proposal for cooking food ingredients used in the heat cooking appliance 3. The store terminal 20 acquires the cooking food ingredient shipping proposal created by the shipping processor 124 and outputs the acquired cooking food ingredient shipping proposal to the display 21.

Because this enables an employee of the store 2, for example, to refer to the shipping proposal created by the management device 10 in making appropriate cooking food ingredient orders and shipping, the management system 1 according to the present embodiment enables efficient heat cooking of food ingredients. Thus, the management system 1 according to the present embodiment enables heat cooking of food ingredients with further improved efficiency.

By shipping cooking food ingredients based on a shipping proposal created by the management device 10, the management system 1 according to the present embodiment, for example, can reduce the disposal of leftover products that have not been sold after heat cooking and products that are stored in a freezer before heat cooking. For example, by reducing the products stored in a freezer before heat cooking, the management system 1 according to the present embodiment can save electrical energy used to maintain the freezer.

In the present embodiment, the usage information includes the time that a heat cooking appliance 3 was used in heat cooking and product identification information (for example, the cooking key and cooking menu item) that identifies the product cooked by heating. The usage information tabulation unit 123, based on the usage time and the product identification information, tabulates the number of times a heat cooking appliance 3 is used with respect to a product and a prescribed time of day for each store 2. The shipping processor 124, based on the number of times the heat cooking appliance 3 is used with respect to the product and the prescribed time of day, creates a shipping proposal, for each store 2, for cooking food ingredients corresponding to the product.

Because this tabulates the number of times a heat cooking appliance 3 is used for a product or a time of day, management system 1 according to the present embodiment can, for example, accurately analyze the number of times a heat cooking appliance 3 is used for each product or each time of day. Thus, the management system 1 according to the present embodiment enables creation of a proposal for shipping of cooking food ingredients with more improved accuracy.

Because tabulation is done for each product or each time of day, the management system 1 according to the present embodiment can enable an understanding of the good-selling products and times of the day of good sales for each store 2.

The shipping processor 124 may determine the sequence of shipping cooking food ingredients to a plurality of stores 2 based on the tabulated results for each store 2. In this case, the management system 1 according to the present embodiment can ship cooking food ingredients to a plurality of stores 2 with good efficiency.

The management system 1 according to the present embodiment has a store information storage 112 that stores, in association with each other, the device ID and the store ID (store identification information) that identifies the store 2 in which the heat cooking appliance 3 corresponding to the device ID is installed. The usage information tabulation unit 123 reads out from the store information storage 112 the store IDs associated with the device IDs acquired by the usage information acquisition unit 122 and tabulates the usage information for each store 2 corresponding to the store IDs.

Because this enables the management system 1 according to the present embodiment to determine the store ID from the device ID, it is easy to tabulate usage information for each store 2.

Although in the above-described present embodiment an example has been described in which the management device 10 has a management storage 11, in the management system 1 the heat cooking appliance 3 or store terminal 20, or an external server of the management device 10 may have the management storage 11.

In the present embodiment, the management device 10 has a setting change processor 121 (change processor) that generates, in response to a product change, a setting change instruction that changes the cooking keys 31A (setting keys) to which heat cooking corresponding to products to be heat cooked in the heat cooking appliance 3 can be set and the heat cooking corresponding to the cooking keys 31A. The heat cooking appliance 3, based on a setting change instruction generated by the setting change processor 121, changes the settings of heat cooking corresponding to the cooking keys 31A.

This enables the management system 1 according to the present embodiment to easily change the settings of the heat cooking appliance 3 in response to a product change.

Because the management device 10 can, by acquiring the usage information of the heat cooking appliance 3, confirm whether or not the heat cooking setting change has been made by the store 2 based on the setting change instruction, the management system 1 according to the present embodiment can reliably execute a heat cooking setting change for which an instruction has been made to each store 2.

The management device 10 according to the present embodiment has a usage information acquisition unit 122 and a usage information tabulation unit 123. The usage information acquisition unit 122 acquires a device ID that identifies a heat cooking appliance 3 and usage information obtained according to use of the heat cooking appliance 3. The usage information tabulation unit 123 tabulates usage information acquired by the usage information acquisition unit 122 for each store 2 in which a heat cooking appliance 3 corresponding to a device ID acquired by the usage information acquisition unit 122 is installed.

This enables the management device 10 according to the present embodiment, similar to the management system 1, to cook food ingredients by heating with good efficiency.

A management method according to the present embodiment includes an acquisition step, a tabulation step, and an output step. In the acquisition step, the management device 10 acquires the device ID that identifies a heat cooking appliance 3 and usage information obtained in accordance with use of the heat cooking appliance 3. In the tabulation step, the management device 10 tabulates the usage information acquired by the acquisition step for each store 2 in which a heat cooking appliance 3 corresponding to a device ID acquired by the acquisition step is installed. In the output step, the store terminal 20 acquires the tabulated results tabulated by the tabulation step and outputs the acquired tabulated results to the display 21.

This enables the management method according to the present embodiment, similar to the management system 1, to cook food ingredients by heating with good efficiency.

### Second Embodiment

Next, a management system according to the second embodiment will be described, with reference made to drawings.

In the present embodiment, the (Processing 2) described above with reference to FIG. 1 will be described in detail. That is, in the present embodiment, an example will be described in which, for example, based on the usage information acquired from the heat cooking appliance 3, feedback is done to a maintenance instruction such as changing the cooking key allocations to prevent deterioration of the cooking keys.

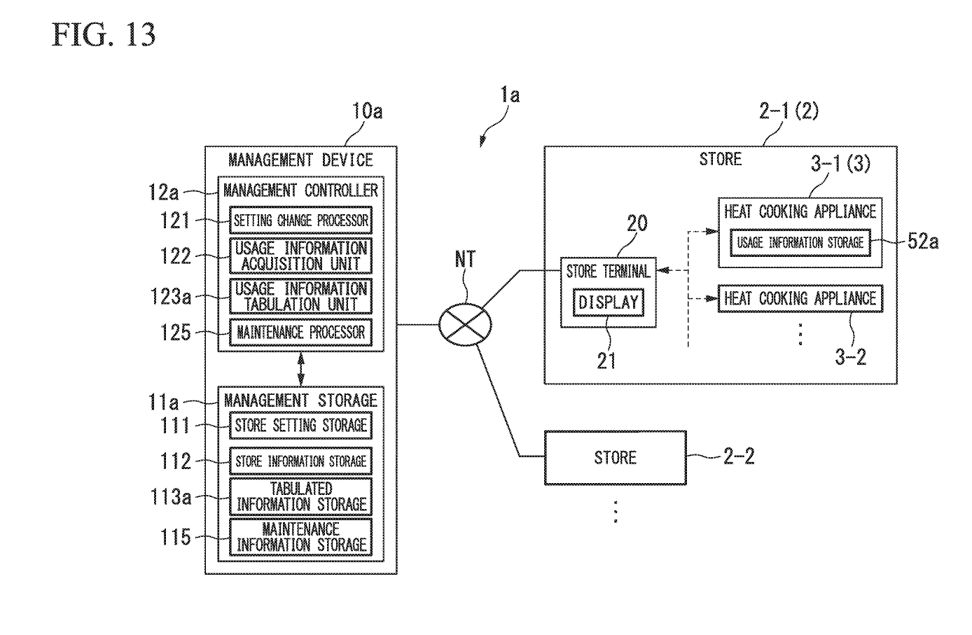

FIG. 13 is a block diagram showing an example of a management system 1a according to the present embodiment.

The management system 1a has a management device 10a, and the store terminal 20 and heat cooking appliances (3-1, 3-2, . . . ) of the stores (2-1, 2-2, . . . ).

In this drawing, constituent elements that are the same as shown in FIG. 1 are assigned the same reference numerals and the descriptions thereof will be omitted.

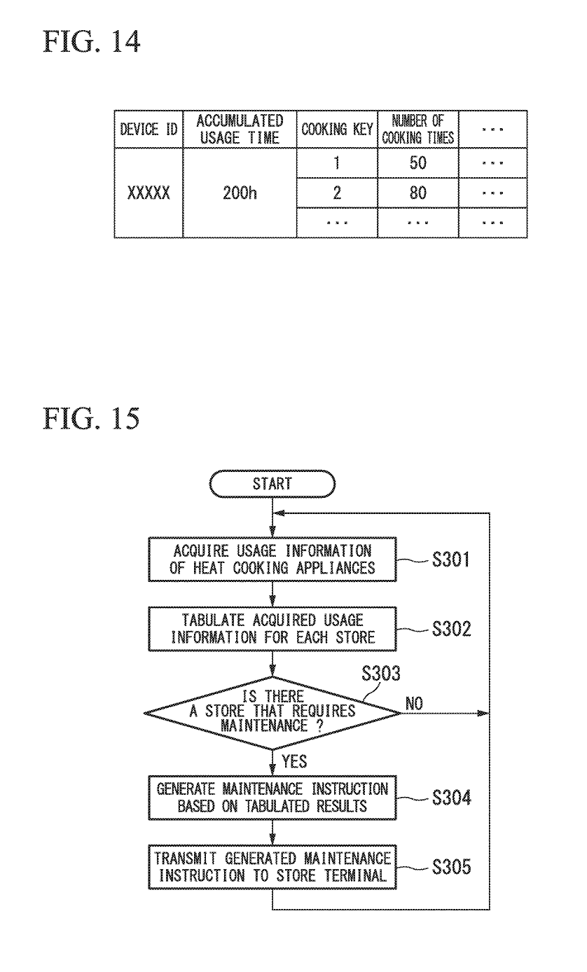

The usage information storage 52a of the present embodiment stores usage information obtained in accordance with use of a heat cooking appliance 3. The usage information storage 52a stores, for example as shown in FIG. 14, the device ID, the accumulated usage time, the cooking key, and the number of cooking times, in association with each other.

FIG. 14 shows an example of the data in the usage information storage 52a in the present embodiment.

In this case, the accumulated usage time, the cooking key, and the number of cooking times are examples of usage information. The usage information includes at least a cooking key number (setting key identification information) that identifies a cooking key 31A and information that indicates the usage status of that cooking key 31A (for example, number of cooking times and accumulate usage time). The accumulated usage time indicates the accumulated usage time of the heat cooking appliance 3.

The example shown in FIG. 14, for example, shows that the accumulated usage time of the heat cooking appliance 3 having the device ID of XXXXX is 200 hours, and that the cooking keys 1 and 2 have been used 50 and 80 times, respectively.

Each time the heat cooking appliance 3 in the present embodiment is used, usage information such as shown in FIG. 14 is stored into the usage information storage 52a.

Returning to the description of FIG. 13, the management device 10a, for example, is a computer of a convenience store headquarters that performs overall control of each store 2. The management device 10a, for example, has a management storage 11a and a management controller 12a.

The management storage 11 a stores various information that is used when each type of processing is executed by the management device 10a. The management storage 11a, for example, has a store setting storage 111, a store information storage 112, a tabulated information storage 113a, and a maintenance information storage 115. The management storage 11a having the tabulated information storage 113a and the maintenance information storage 115 in place of the tabulated information storage 113 and the shipping information storage 114 is different from the first embodiment.

The tabulated information storage 113a stores information indicating the tabulated results of tabulating the usage information that is stored by the heat cooking appliance 3. In this case, the tabulated results are, for example, the results of tabulating the accumulated usage time of each heat cooking appliance 3, for each store 2, and the number of usages for each of the cooking key in the heat cooking appliance 3. The tabulated information storage 113a stores, for example, the store ID, the device ID, the accumulated usage time, the cooking key, and the number of cooking times, in association with each other. The information indicating the tabulated results stored by the tabulated information storage 113a are stored by the usage information tabulation unit 123a, which will be described later.

The maintenance information storage 115 stores information that indicates a maintenance instruction that maintains each heat cooking appliance 3. The information indicating the maintenance instruction is generated by the maintenance processor 125, which will be described later, and is stored in the maintenance information storage 115. The maintenance information storage 115 stores, for example, change instruction information that exchanges the settings (heat cooking settings) of 1 and 9 of the cooking keys 31A, information of a replacement instruction that replaces parts of each of the heat cooking appliances 3, and additional instruction information for consumable items.

The management controller 12a, for example, is a processor that includes a CPU or the like, and performs overall control of the management device 10a. The management controller 12a has, for example, a setting change processor 121, a usage information acquisition unit 122, a usage information tabulation unit 123a, and a maintenance processor 125. The management controller 12a having the usage information tabulation unit 123a and the maintenance information storage 125 in place of the usage information tabulation unit 123 and the shipping processor 124 is different from the first embodiment.

The usage information tabulation unit 123a (an example of a tabulation unit), for each store 2 in which a heat cooking appliance 3 corresponding to a device ID acquired by the usage information acquisition unit 122 is installed, tabulates the usage information acquired by the usage information acquisition unit 122. In this case, the usage information includes the cooking key number (the cooking key) and information indicating the usage state of the cooking key 31A (for example, the accumulated usage time and number of cooking times). The usage information tabulation unit 123a, for example, based on information that indicates the cooking key number and the usage state of the cooking key 31A, tabulates the number of usages for each of the cooking keys 31A in the heat cooking appliance 3. The usage information acquired by the usage information acquisition unit 122 is information recorded at a prescribed interval, and the usage information tabulation unit 123a generates for each store 2 information of the accumulated usage information acquired by the usage information acquisition unit 122.

The usage information tabulation unit 123a records the tabulated results into the tabulated information storage 113a. The usage information tabulation unit 123a, for example, in response to a request from a store terminal 20 of the stores 2, transmits the tabulated results to the store terminal 20. In this case, the store terminal, for example, acquires the tabulated results tabulated by the usage information tabulation unit 123a and outputs the acquired tabulated results to the display 21.

The maintenance processor 125, based on the tabulated results tabulated by the usage information tabulation unit 123a, generates a maintenance instruction that maintains the heat cooking appliance 3. The maintenance processor 125, for example, based on the accumulated usage time, generates for the heat cooking appliance 3 maintenance instructions, such as a cleaning instruction (for example an instruction to clean the inside of the heating chamber), a parts replacement instruction, or an addition instruction for consumable items (for example, supplying of water). The maintenance processor 125, for example, based on the accumulated times of usage of each cooking key 31A, generates as a maintenance instruction an instruction to interchange the settings of a frequently used cooking key 31A for which there is great possibility of failure with a cooking key 31A that has a small number of usages. That is, the maintenance processor 125, based on the number of usages for each of the cooking keys 31A in the heat cooking appliance 3, generates a maintenance instruction to change the heat cooking settings corresponding to the cooking keys 31A.

The maintenance processor 125 stores the created maintenance instruction into the maintenance information storage 115. The shipping processor 124, for example, transmits a generated maintenance instruction to the store terminal 20 of a store 2 that requires maintenance. In this case, the store terminal 20, for example, acquires the maintenance instruction generated by the maintenance processor 125 and outputs the acquired maintenance instruction to the display 21. An employee of the store 2 performs maintenance in accordance with the maintenance instruction or requests maintenance from a maintenance vender. If the maintenance instruction includes the change of the settings of cooking keys 31A, the store terminal 20 may store the setting change into a USB memory and execute the setting changes of the cooking keys 31A of the heat cooking appliance 3 via the USB memory. The maintenance processor 125 may, based on the generated maintenance instruction, make a request for maintenance to a maintenance vender. The maintenance processor 125 may, based on the generated maintenance instruction, generate a maintenance schedule for the heat cooking appliance 3.

Next, referring to FIG. 15, the operation of the management system 1a according to the present embodiment will be described.

FIG. 15 is a flowchart showing an example of the feedback processing of usage information by the management system 1a according to the present embodiment.

In the present embodiment, an example in which the management system 1a feeds back the usage information to a maintenance instruction will be described.

As shown in the FIG. 15, the usage information acquisition unit 122 of the management device 10a acquires usage information of the heat cooking appliances 3 (step S301). That is, the usage information acquisition unit 122 acquires, via a USB memory, the device ID and usage information of the heat cooking appliances 3 from the store terminals 20 (for example, the accumulated usage time, cooking keys, and number of cooking times).

Next, the usage information tabulation unit 123a tabulates the acquired specification information for each store 2 (step S302). The usage information tabulation unit 123a, for example, reads out from the store information storage 112 the store IDs associated with the device IDs acquired by the usage information acquisition unit 122 and tabulates, for each store 2, the usage information for each of the stores 2 corresponding to the store IDs. The usage information tabulation unit 123a, for example, tabulates the number of times each cooking key 31A of the heat cooking appliances 3 are used. The usage information tabulation unit 123a stores the tabulated results into the tabulated information storage 113a.

Next, the maintenance processor 125 determines whether or not there is a store 2 that requires maintenance (step S303). The maintenance processor 125, for example, references the tabulated results stored in the tabulated information storage 113a and determines whether or not there is a store 2 requiring maintenance. If the number of usages for each cooking key 31A reaches a prescribed number of times or the accumulated usage time reaches a prescribed amount of time, the maintenance processor 125 determines that maintenance is required. If there is a store 2 requiring maintenance (YES at step S303), the maintenance processor 125 proceeds to step S304. If there is no store 2 requiring maintenance, the maintenance processor 125 returns processing to step 5301 (NO at step S303).

At step S304, the maintenance processor 125 generates a maintenance instruction based on the tabulated results stored in the tabulated information storage 113a. For example, the maintenance processor 125, based on the number of times each cooking key 31A of a heat cooking appliance 3 is used, generates a maintenance instruction that changes the settings of heat cooking corresponding to the cooking keys 31A. The maintenance processor 125 stores the generated maintenance instruction into the maintenance information storage 115.

Next, the maintenance processor 125 transmits the generated maintenance instruction to the store terminal 20 (step S305). In this case, the store terminal 20, for example, acquires the maintenance instruction generated by the maintenance processor 125 and outputs the acquired maintenance instruction to the display 21. The store terminal 20 stores into a USB memory the setting change of the cooking keys 31A, which is the maintenance instruction, and the change of settings of the cooking keys 31A of the heat cooking appliance 3 is executed via the USB memory. After the processing of step S305, the maintenance processor 125 returns the processing to step S301.

As described above, the management system 1a of the present embodiment has a management device 10a and a store terminal 20. The management device 10a has a usage information acquisition unit 122, a usage information tabulation unit 123a, and a maintenance processor 125. The usage information acquisition unit 122 acquires a device IDs that identify heat cooking appliances 3 and usage information obtained in accordance with usage of the heat cooking appliances 3. The usage information tabulation unit 123a, for each store 2 in which a heat cooking appliance 3 corresponding to a device ID acquired by the usage information acquisition unit 122 is installed, tabulates the usage information acquired by the usage information acquisition unit 122. The maintenance processor 125, based on the tabulated results tabulated by the usage information tabulation unit 123a, generates a maintenance instruction to maintain the heat cooking appliances 3. The store terminal 20 acquires the maintenance instruction generated by the maintenance processor 125 and outputs the acquired maintenance instruction to the display 21.

Because, doing this, the management system 1a according to the present embodiment, based on the usage information of the heat cooking appliances 3, generates heat cooking appliance 3 maintenance instructions, it is possible to reduce the deterioration of performance and failures in the heat cooking appliances 3. Thus, the management system 1a according to the present embodiment can cook food ingredients by heating with good efficiency.

In the present embodiment, the usage information includes cooking key numbers (cooking keys) that identify the cooking keys 31A, that can be set to heat cooking corresponding to products that are cooked by heat, and information indicating the usage state of these cooking keys 31A (for example, accumulated usage time and number of cooking times). The usage information tabulation unit 123a, based on the cooking key numbers and the information indicating the usage state of the cooking keys 31A in the heat cooking appliance 3, tabulates the number of usages for each of the cooking keys 31 in the heat cooking appliance 3. The maintenance processor 125 generates a maintenance instruction to change the settings of the heat cooking corresponding to each of the cooking keys 31A, based on the number of usages of each of the cooking keys 31A of the heat cooking appliance 3.

By doing this, the management system 1a according to the present embodiment, for example, can make a setting change that interchanges the settings of a cooking key 31A that is frequently used for which there is a great possibility of failure with a cooking key 31A that has a small number of usages. Thus, it is possible for the management system 1a of the present embodiment to reduce the deterioration of performance and failure of the heat cooking appliance 3 and to lengthen the period of operation of the heat cooking appliance 3. The management system 1a according to the present embodiment can also reduce the cost of maintaining the heat cooking appliance 3.

In the present embodiment, the usage information includes the usage time of the heat cooking appliance 3. The usage information tabulation unit 123a tabulates the accumulated usage time for each heat cooking appliance 3, based on the usage time of the heat cooking appliances 3.

This enables the management system 1a according to the present embodiment to make appropriate determination regarding, for example, maintenance instructions to clean the heat cooking appliance 3, instructions to replace parts, and to add consumable items, and the timing of replacement of the heat cooking appliance 3.

The management device 10a according to the present embodiment has the above-described usage information acquisition unit 122, usage information tabulation unit 123a, and maintenance processor 125.

Because, similar to the above-described management system 1a, the management device 10a according to the present embodiment can reduce the deterioration of performance and failures of the heat cooking appliance 3, it can cook food ingredients by heating with good efficiency.

The management method according to the present embodiment has an acquisition step, a tabulation step, a maintenance processing step, and an output step. In the acquisition step, the management device 10a acquires the device IDs that identify heat cooking appliances 3 and usage information that is acquired in accordance with usage of the heat cooking appliances 3. In the tabulation step, the management device 10a, for each store 2 in which a heat cooking appliance 3 corresponding to a device ID acquired in the acquisition step is installed, tabulates the usage information acquired in the acquisition step. In the maintenance processing step, the management device 10a, based on the tabulation results tabulated in the tabulation step, generates a maintenance instruction that maintains the heat cooking appliances 3. In the output step, the store terminal 20 acquires the maintenance instruction generated in the maintenance processing step and outputs the acquired maintenance instruction to the display 21.

Because this enables the management method according to the present embodiment, similar to the above-described management system 1a, to reduce the deterioration of performance and failures of the heat cooking appliance 3, it is possible to cook food ingredient with heat with good efficiency.

### Third Embodiment

Next, a management system according to the third embodiment of will be described, with references to drawings.

In the present embodiment, the (Processing 3) described above with reference to FIG. 1 will be described in detail. That is, in the present embodiment, an example will be described in which, for example, based on the usage information acquired from the heat cooking appliance 3, feedback is done to a food ingredient proposal, such as a request for development of cooking food ingredients and a processing instruction.

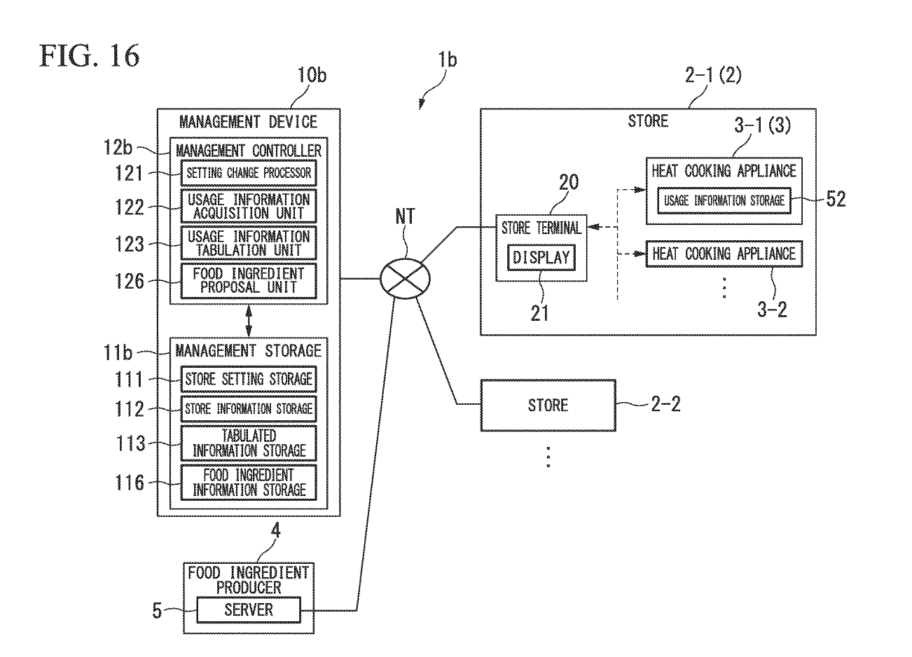

FIG. 16 is a functional block diagram showing an example of a management system 1b according to the present embodiment.

The management system 1b has a management device 10b, the store terminal 20 and heat cooking appliances (3-1, 3-2, . . . ) of the stores (2-1, 2-2, . . . ), and a server 5 of a food ingredient producer 4.

In this drawing, constituent elements that are the same as shown in FIG. 1 are assigned the same reference symbols, and the descriptions thereof will be omitted.

The food ingredient producer 4 (food ingredient developing vender) develops food ingredients in accordance with the products. The food ingredient producer 4, for example, based on a cooking food ingredient development request proposed by the management device 10b, develops a cooking food ingredient to match the heat cooking of the heat cooking appliance 3. The food ingredient producer 4, based on a cooking food ingredient proposal such as a processing instruction proposed by the management device 10b, processes cooking food ingredients. The food ingredient producer 4, for example, has a server 5 that accepts cooking food ingredient proposals from the management device 10b.

The server 5 is a computer of the food ingredient producer 4.

The management device 10b, for example, is a computer of the convenience store headquarters that performs overall management of the stores 2. The management device 10b has, for example, a management storage 11b and a management controller 12b.

The management storage 11b stores various information used when the management device 10b executes various processing. The management storage 11b has, for example, a store setting storage 111, a store information storage 112, a tabulated information storage 113, and a food ingredient information storage 116. The management storage 11b having the food ingredient information storage 116 in place of the shipping information storage 114 is different from the first embodiment.

The food ingredient information storage 116 stores proposal information of a cooking food ingredient proposed for heat cooking by the heat cooking appliance 3. The proposal information is proposed by the food ingredient proposal unit 126, which will be described later, and stored into the food ingredient information storage 116. The food ingredient information storage 116 stores, for example, proposal information that proposes changes of food ingredients that are semi-cooked items that will become finished items by heat cooking by the heat cooking appliance 3 and of heating conditions of heat cooking in accordance with the region (area).

The management controller 12b is, for example, a processor that includes a CPU or the like and performs overall control of the management device 10b. The management controller 12b has, for example, a setting change processor 121, a usage information acquisition unit 122, a usage information tabulation unit 123, and a food ingredient proposal unit 126. The management controller 12b having the food ingredient proposal unit 126 in place of the shipping processor 124 is different from the first embodiment.

The food ingredient proposal unit 126, based on the tabulated results tabulated by the usage information tabulation unit 123, proposes food ingredients for heat cooking by the heat cooking appliance 3. The food ingredient proposal unit 126, for example, proposes food ingredients that are semi-cooked items that will become finished items by heat cooking by the heat cooking appliance 3, based on the tabulated results. For example, the food ingredient proposal unit 126, based on the tabulated results, proposes a food ingredient that is curry bun dough that is half-baked and can be cooked by heating in the heat cooking appliance 3. That is, the food ingredient proposal unit 126 proposes a food ingredient that has been cooked by heating partway, so that the baked condition (color and aroma) can be completed by the set heat cooking time and temperature of the heat cooking appliance 3. The food ingredient proposal unit 126, for example, based on the tabulated results, proposes a food ingredient of a half-cooked item in accordance with the heat cooking setting set to the cooking key 31A that can be set to heat cooking in the heat cooking appliance 3. For example, if the temperature setting and the time setting set to the cooking key 31A 1 are 250 degrees and 10 minutes, the food ingredient proposal unit 126 proposes a food ingredient that is suitable for heat cooking at 250 degrees for 10 minutes.

Based on the tabulated results, the food ingredient proposal unit 126 may propose an increase or decrease in the produced amount of food ingredient, the size of cooking food ingredient, the number of units in a pack, or a stepped adjustment of the flavor thereof (for example, changing the sauce flavor from rich to light, and sauce flavor). The food ingredient proposal unit 126, for example, may grasps from the tabulated results the trend of the products that are selling, and generate a proposal for a change in the processed state, the baking condition, and the flavoring or the like of a cooking food ingredient.

The food ingredient proposal unit 126 stores into the food ingredient information storage 116 the generated proposal information that proposes the generated food ingredient. The food ingredient proposal unit 126, for example, in response to a request for feedback to the food ingredient, proposes a cooking food ingredient and, transmits the cooking food ingredient proposal, for example, to the food ingredient producer 4 (server 5).

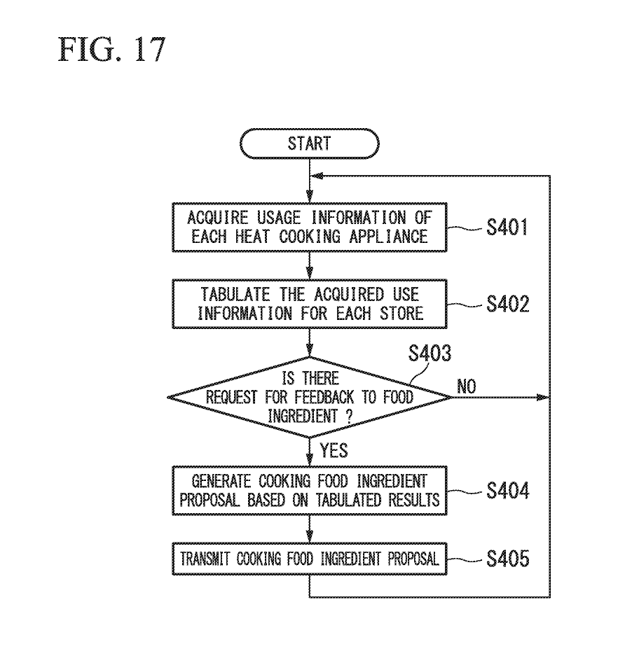

Next, the operation of the management system 1b according to the present embodiment will be described, with reference made to FIG. 17.

FIG. 17 is a flowchart showing an example of the usage information feedback processing by the management system 1b of the present embodiment.

In the present embodiment, an example in the case in which the management system 1b performs feedback to a cooking food ingredient proposal will be described.

Because the processing of step S401 and step S402 shown in FIG. 17 are the same as the processing of step S101 and step S102 shown in FIG. 11, the descriptions thereof will be omitted here.

Next, the food ingredient proposal unit 126 determines whether or not there is a request for feedback to the food ingredient (step S403). In this case, the request for feedback to the food ingredient may be a request from the convenience store headquarters or may be a request from any of the stores 2 (store terminals 20) or a food ingredient producer 4 (server 5). If there is a request for feedback to the food ingredient (YES at step S403), the food ingredient proposal unit 126 proceeds to the processing of step S404. If there is no request for feedback to the food ingredient (YES at step S403), the food ingredient proposal unit 126 returns to the processing of step S401).

At step S404, the food ingredient proposal unit 126, based on the tabulated results stored in the tabulated information storage 113, generates a cooking food ingredient proposal. The food ingredient proposal unit 126, for example, makes a cooking food ingredient proposal for a cooking food ingredient cooked by heat midway beforehand, so that the degree of baking (baked color and aroma) is completed in the set heat cooking time and the heating temperature of the heat cooking appliance 3. The maintenance processor 125 stores the proposal information, which is the generated proposal for cooking food ingredients, into the food ingredient information storage 116.

Next, the food ingredient proposal unit 126 transmits the cooking food ingredient proposal (step S405). That is, the food ingredient proposal unit 126 transmits proposal information to be stored into the food ingredient information storage 116 to the originator of the request for feedback to food ingredients (for example, the food ingredient producer 4). If the originator of the request for feedback to food ingredients is the convenience store headquarters or a store 2, the food ingredient proposal unit 126 may be made to transmit to the convenience store headquarters or the store 2 (store terminal 20), and may be made to transmit to the food ingredient producer 4 (server 5). If the convenience store headquarters or a store 2 (store terminal 20) has acquired proposal information for cooking food ingredients, the convenience store headquarters or the store 2 (store terminal 20) considers the content of the proposal information and, if a determination is made to make a proposal to the food ingredient producer 4, it transmits the proposal information to the food ingredient producer 4 (server 5). After the processing of step S405, the food ingredient proposal unit 126 returns the processing to step S401.

As described above, the management system 1b according to the present embodiment has a management device 10b, and the management device 10b has a usage information acquisition unit 122, a usage information tabulation unit 123, and a food ingredient proposal unit 126. The usage information acquisition unit 122 acquires the device ID that identifies the heat cooking appliance 3 and usage information obtained by use of the heat cooking appliance 3. The usage information tabulation unit 123 tabulates, for each store 2 in which a heat cooking appliance 3 corresponding to the device ID acquired by the usage information acquisition unit 122 is installed, usage information acquired by the usage information acquisition unit 122. The food ingredient proposal unit 126, based on the tabulated results tabulated by the usage information tabulation unit 123, proposes cooking food ingredients to be cooked with heat by the heat cooking appliance 3, and transmits the proposed cooking food ingredient to the server 5 of the cooking food ingredient development vender.

Because this enables the management system 1b according to the present embodiment, based on the usage information of the heat cooking appliance 3, to make a cooking food ingredient proposal for heat cooking by the heat cooking appliance 3, heat cooking of food ingredients by heating can be done with good efficiency. The management system 1b according to the present embodiment can also provide a product suitable for the heat cooking appliance 3. That is, the management system 1b according to the present embodiment can provide a product with a high cooking quality, such as baked color, degree of baking, and aroma.

In the present embodiment, the food ingredient proposal unit 126, based on tabulated results, proposes food ingredients of a half-cooked product that will become a finished item by heat cooking by the heat cooking appliance 3.

This, for example, enables the management system 1b according to the present embodiment to, for example, provide a product by heat cooking in a shorter time by the heat cooking appliance 3, thereby providing heating-cooked products with good efficiency.

In the present embodiment, the food ingredient proposal unit 126, based on tabulated results, proposes cooking food ingredient that are half-cooked in accordance with heat cooking set at cooking keys 31A that can be set to heat cooking settings in the heat cooking appliance 3.

This enables the management system 1b according to the present embodiment to develop and improve cooking food ingredient matched to the settings at the cooking keys 31A, thereby enabling heat cooking with better efficiency.

The management system 10b according to the present embodiment has a usage information acquisition unit 122, a usage information tabulation unit 123, and a food ingredient proposal unit 126. The usage information acquisition unit 122 acquires the device ID that identifies the heat cooking appliance 3 and usage information obtained by use of the heat cooking appliance 3. The usage information tabulation unit 123 tabulates, for each store 2 in which a heat cooking appliance 3 corresponding to the device ID acquired by the usage information acquisition unit 122 is installed, the usage information acquired by the usage information acquisition unit 122. The food ingredient proposal unit 126, based on the tabulated results tabulated by the usage information tabulation unit 123, makes a proposal for cooking food ingredient to be cooked with heat by the heat cooking appliance 3.

Because this enables the management system 10b according to the present embodiment, similar to the above-described management system 1b, to make a cooking food ingredient proposal for heat cooking by the heat cooking appliance 3, heat cooking of cooking food ingredients is possible with good efficiency.

A management method according to the present embodiment includes an acquisition step, a tabulation step, and a food ingredient proposal step. In the acquisition step, the management system 10b acquires the device ID identifying a heat cooking appliance 3 and the usage information obtained in accordance with use of the heat cooking appliance 3. In the tabulation step, the management system 10b, for each store 2 in which a heat cooking appliance 3 corresponding to an device ID acquired by the acquisition step is installed, tabulates the usage information acquired by the acquisition step. In the food ingredient proposal step, the management system 10b, based on the tabulated results tabulated by the tabulation step, proposes cooking food ingredients for heat cooking by the heat cooking appliance 3 and transmits the proposed cooking food ingredient to the server 5 of the food ingredient producer 4 (food ingredient developing vender).

Because this enables the management method according to the present embodiment, similar to the above-described management system 1b, to propose cooking food ingredient that will be heat cooked by the heat cooking appliance 3, heat cooking of cooking food ingredients is possible with good efficiency.

The present invention is not restricted to the above-noted embodiments, and can be changed, within the scope of the spirit thereof.

For example, although the above-noted embodiments are described by independently embodied examples, an embodiment may combine the above-noted embodiments.

In the above-noted embodiments, the description has been for the example in which the information exchange is done via a USB memory between the store terminal 20 and the heat cooking appliance 3, this is not a restriction. For example, the external interface 34 may be a wireless LAN (Local Area Network) interface or a cable LAN interface, and exchange of information may be done via a wireless LAN or a cable LAN between the store terminal 20 and the heat cooking appliance 3. The heat cooking appliance 3 may be directly connected to the network NT and perform information exchange directly with the management system 10 (10a, 10b), without going through the store terminal 20. In that case, the heat cooking appliance 3 may have a part or all of the functions of the store terminal 20. If the heat cooking appliance 3 is directly connected to the network NT, a management system 10 (10a, 10b) may be allocated to the cooking keys 31A of each heat cooking appliance 3, and the heat cooking setting may be directly changed via the network NT. When allocating the cooking keys 31A and changing the heat cooking settings, the controller 60 of the heat cooking appliance 3 may provide, as speech from the speech output 33 as a voice, notification of an instruction to change settings, or to allocate cooking keys 31A and change the heat cooking settings. In that case, the management system 10 (10a, 10b) may periodically acquire usage information from the heat cooking appliance 3 and may acquire usage information each time the heat cooking appliance 3 is used.

Although the above-noted embodiments have been described for the example in which, as an example of an output, information such as tabulated results, shipping proposals, and maintenance instructions and the like are output to the display 21, this is not a restriction. For example, the output may be one that outputs information to paper of a printer or the like, or one that outputs information to a file.

In the above-noted embodiments, a part or all of the management storage 11 (11a, 11b) may be provided outside the management system 10 (10a, 10b). For example, a part or all of the management storage 11 (11a, 11b) may be provided in a server connected to the network NT.

In the above-noted embodiments, although the example described has been one in which the usage information includes information such as the device ID, the cooking time, the cooking key, the cooking menu item, the heating mode, the temperature setting, the time setting, the accumulated usage time, and the number of cooking times or the like, this is not a restriction. For example, the usage information may include other information, such as the time interval between usage of the heat cooking appliance 3 or the degree of baking. The tabulated results tabulated by the usage information tabulation unit 123 (123a) are not restricted to the above-noted embodiments. For example, the tabulated results may be tabulated for each store 2 and, in addition, may be tabulated for each area, and for each unit of one day or a day of the week, a month, or a season. The tabulated results may include the interval of usage of the heat cooking appliance 3, the number of times of continuous or simultaneous use, or the like.

In the above-noted embodiments, although the description has been an example in which the heat cooking appliance 3 is a cooker corresponding to a microwave oven, an oven/grill, or a water oven or water grill, these are not restrictions. For example, the heat cooking appliance 3 may be a cooker corresponding to one or some of a microwave oven, oven/grill, and water oven/water grill and, as long as it can record usage information, may be a cooker that heats using a high-speed air circulating technique, an oven toaster, or a hot plate or other cooking device.

In the above-noted embodiments, although the description has been an example in which the store 2 is a convenience store, this is not a restriction and, for example, the store 2 may be a restaurant such as a family restaurant, or an eating establishment such a fast-food store.

In the above-noted first embodiment, the shipping proposal created by the shipping processor 124 may include the processed state of a cooking food ingredient (for example, in a store 2 in which it does not sell much, a state that is suitable for storage). The state at the time of shipping of a cooking food ingredient may be changed by the store 2, to frozen, half-frozen, partial frozen, chilled, or the like.

Although an example in which a cooking food ingredient shipping proposal is transmitted to the store terminal 20 has been described as one example of a terminal device to which the shipping processor 124 sends a cooking food ingredient shipping proposal, a cooking food ingredient shipping proposal may be transmitted to a terminal device or the like of a convenience store headquarters, in which case arrangement is made by the convenience store headquarters for shipping of the cooking food ingredient.

In the above-noted second embodiment, the heat cooking appliance 3 may have the tabulated information storage 113 of the first and third embodiment in place of the tabulated results storage 113a. That is, the usage information may be information such as shown in FIG. 3, similar to the first and third embodiments.

In the above-noted third embodiment, the heat cooking appliance 3 may adjust the flavor, such as the baked color and aroma, in stepwise fashion, and record this as usage information, in which case the usage information tabulation unit 123a may tabulate the flavor preferences for each area, and the food ingredient proposal unit 126 may create a cooking food ingredient proposal for development and processing instructions for the cooking food ingredient.

In the above-noted third embodiment, although the description has been an example in which the management device 10b has a food ingredient proposal unit 126 that creates a cooking food ingredient proposal, a food engineer may make a cooking food ingredient proposal, based on the tabulated results.

In the above-noted embodiments, when the heat cooking appliance 3 has executed a setting change, the controller 60 of the heat cooking appliance 3 may make notification to the effect that a setting change has been executed by a display from the liquid crystal display 32. When the heat cooking appliance 3 used after the heat cooking appliance 3 executes a setting change, the controller 60 may made notification to the effect that a setting change has been executed by a display from the liquid crystal display 32.

After the heat cooking appliance 3 executes a setting change, the controller 60 of the heat cooking appliance 3 may, during the use of the heat cooking appliance 3 a prescribed number of times or over a time until a prescribed period of time has elapsed, make a notification to the effect that a setting change has been executed, either from the liquid crystal display 32 or from the speech output 33.

In the above-noted embodiments, the store terminal 20 may have a part or all of the constituent elements of the management system 10, 10a, 10b (for example, the setting change processor 121, the usage information acquisition unit 122, the usage information tabulation unit 123, the shipping processor 124, 123a, the store setting storage 111, and the store information storage 112). For example, the heat cooking appliance 3 transmits to the store terminal 20 device identification information (device ID), which identifies itself, and usage information obtained by its use. In this case, each time it is used (for example, each time cooking is completed), the heat cooking appliance 3 may transmit the usage information. The usage information acquisition unit 122 of the store terminal 20 may acquire device identification information and usage information transmitted by each of a plurality of heat cooking appliances 3. The usage information tabulation unit 123, 123a of the store terminal 20, for each store in which a heat cooking appliance 3 corresponding to device identification information acquired by the usage information acquisition unit 122, tabulates usage information acquired by the usage information acquisition unit 122. The store terminal 20 transmits the tabulated results to the management device 10, 10a, 10b. The tabulated information storage 113 of the management device 10, 10a, 10b stores the tabulated results received from the store terminal 20. The setting change processor 121 of the store terminal 20 generates a setting change instruction according to a product change that changes the settings of heat cooking corresponding to the cooking keys.

The above-described management system 1 (1a, 1b) has within it a computer system. A program for implementing the functions of the various constituent elements of the above-described management system 1 (1a, 1b) may be recorded in a computer-readable recording medium, and a computer system may be made to read in and execute the program recorded in the recording medium to perform the processing in the constituent elements of the above-described management system 1 (1a, 1b). The term “computer system” used here means computer system incorporated into the management system 1 (1a, 1b), and includes an operating system and hardware such as peripheral devices. The term “computer-readable recording medium” refers to a removable medium such as a flexible disk, an optomagnetic disk, a ROM, a CD-ROM, or to a storage device such as a hard disk built into a computer system. Additionally, the term “computer-readable recording medium” may encompass one holding a program over a short time dynamically such as a communication line when a program is transmitted via a network such as the Internet or via a communication line such as a telephone line and one holding a program for a given period of time, such as a volatile memory within a computer system serving as a server or client. The above-noted program may be for implementing a part of the above-described functionality, and may be one enabling implementation by combination with a program that already has recorded the above-noted functionality in a computer system.

A part or all of the above-described functions may implemented as an integrated circuit such as LSI (large-scale integration). Each of the above-described functions may be implemented by a processor separately or a part or all thereof may be implemented in integrated fashion as a processor. The method of integrated circuit implementation is not restricted to LSI, and implementation may be done by dedicated circuitry or a general-purpose processor. Additionally, in the event of the appearance of integrated circuit implementation taking the place of LSI by advances in semiconductor technology, an integrated circuit using that technology may be used.

That is, summarizing the invention and the embodiments, we have the following.

A management system of an embodiment of the present invention has a management device that has an acquisition unit acquiring device identification information that identifies a heat cooking appliance and usage information obtained according to usage of the heat cooking appliance, and that has a tabulation unit that, for each store in which the heat cooking appliance corresponding to the device identification information that has been acquired by the acquisition unit is installed, tabulates the usage information that has been acquired by the acquisition unit, and a terminal device acquiring and outputting to an output the acquired tabulated results tabulated by the tabulation unit.

According to the above-noted constitution it is possible to cook food ingredients by heating, with good efficiency.

In a management system of an embodiment, the management device has a shipping processor that, based on the tabulated results tabulated by the tabulation unit, creates a shipping proposal for food ingredients used in the heat cooking appliance, and the terminal device may acquire the food ingredient shipping proposal created by the shipping processor and output the acquired food ingredient shipping proposal to the output.

According to the above-noted constitution, because a shipping proposal is created for shipping food ingredients based on the tabulated results tabulated from the cooker, an appropriate shipping proposal can be created.

In a management system of an embodiment, the usage information includes the usage times at which the heat cooking appliance is used in heat cooking and the product identification information that identifies the heat-cooked product, and the tabulation unit, based on the usage time and the product identification information, tabulates the number of times of use of the heat cooking appliance corresponding to the product and a prescribed time of day, for each of the stores, and the shipping processor may, based on the number of times of use of the heat cooking appliance corresponding to the product and the prescribed time of day, create the shipping proposal for each store for food ingredients corresponding to the product.

According to the above-noted constitution, it is possible to grasp the time of day in which the number of uses is large for each store and to create an appropriate shipping proposal.

A management system according to an embodiment has a store information storage that stores the device identification information and store identification information identifying the stores in which the heat cooking appliance corresponding to the device identification information is installed, in association with each other, wherein the tabulation unit reads out from the store information storage the store identification information associated with the device identification information acquired by the acquisition unit and, for each store corresponding to the store identification information, tabulates the usage information.

According to the above-noted constitution, usage information can be tabulated for each store satisfying a prescribed condition (for example, region or store surface area), enabling the acquisition of tabulated results that suit a purpose.

In a management system of an embodiment, the management device may have setting keys that can be set to heat cooking corresponding to products heat-cooked in the heat cooking appliance and may have a change processor that generates a setting change instruction changing the setting of heat cooking corresponding to the setting keys in accordance with a change of the product, wherein the heat cooking appliance, based on the setting change instruction generated by the change processor, changes the settings of heat cooking corresponding to the setting keys.

According to the above-noted constitution, by making the settings of heat cooking corresponding to the setting keys changeable, it is possible to change to preferred settings.

In a management system of an embodiment, the management device may have a maintenance processor that, based on the tabulated results tabulated by the tabulation unit, generates a maintenance instruction for maintenance of the heat cooking appliance, wherein the terminal device acquires a maintenance instruction generated by the maintenance processor and outputs the acquired maintenance instruction to the output.

According to the above-noted constitution, by a maintenance instruction generated by the maintenance processor, it is easy to perform maintenance of the heat cooking appliance. Because a maintenance instruction for a heat cooking apparatus is generated based on usage information of the heat cooking appliance, deterioration of performance and failures of the heat cooking appliance can be reduced.

In a management system on an embodiment, the usage information may include setting key identification information that identifies a setting key that can be set to heat cooking corresponding to a product that is to be cooked by heat and information that indicates the usage state of the setting key, wherein, based on the key identification information and the information indicating the usage state of the setting key, the tabulation unit may tabulate the number of times of use for each setting key of the heat cooking appliance and, based on the number of times of use of each setting key of the heat cooking appliance, the maintenance processor may generate the maintenance instruction that changes the settings of heat cooking corresponding to the setting keys.

According to the above-noted constitution, by changing the settings of heat cooking based on the number of times of use of keys and exchanging the heat cooking settings with other keys having few times of usage, it is possible to prevent a drastic reduction in the life of specific keys only.

In a management system of an embodiment, the usage information may include the usage time of the heat cooking appliance, and the tabulation unit may, based on the usage time of the heat cooking appliance, tabulate the accumulated usage time for each heat cooking appliance.

According to the above-noted constitution, for example, it is possible to understand things such as, in a given store, only a specific heat cooking appliance is used, this being useful in maintenance and in changing functions. That is, for example, it is possible to make appropriate maintenance instructions for cleaning of a heat cooking appliance, parts replacement, addition of consummables, and the like, and to judge the timing of replacement of a heat cooking appliance.

In a management system of an embodiment, the management device may have a food ingredient proposal unit that, based on the tabulated results tabulated by the tabulation unit, proposes food ingredients to be heat-cooked by the heat cooking appliance.

According to the above-noted constitution, this is useful, based on the cooking menu items often used for each heat cooking appliance, in considering cooking menu items using, for example, the same food ingredients. According to the above-noted constitution, because cooking food ingredients for heat cooking by the heat cooking appliances are proposed, it is possible to cooking by heating with good efficiency. According to the above-noted constitution, it is possible to provide products that are suitable to the heat cooking appliance. That is, the management system can propose products with a high cooking quality, such as baked color, degree of baking, aroma and the like.

In a management system according to an embodiment, the food ingredient proposal unit may propose half-cooked food ingredients that will become finished items by heat cooking by the heat cooking appliance.

According to the above-noted constitution, based on the tabulated results, it is possible to propose half-cooked items that are often heat cooked, that is, food ingredients in line with the preferences of consumers in the location in which the tabulated heat cooking appliances are installed, which become finished items by heat cooking by the heat cooking appliance. For example, it is possible to provide products cooked with heat with good efficiency, so as to provide heat-cooked products in a short time by the heat cooking appliance.

In a management system of an embodiment, the food ingredient proposal unit may propose food ingredients of a half-cooked item in accordance with the heat cooking setting set at a setting key to which heat cooking settings can be set in the heat cooking appliance.

According to the above-noted constitution, it is possible to propose half-cooked items that, with heat cooking by the heat cooking appliance become finished items, using food ingredients corresponding to often-used setting keys of the heat cooking appliance, based on the tabulated results, that is, in line with the preferences of consumers in a location in which a tabulated heat cooking appliance is installed.

A management system of an embodiment may have a management device that has an acquisition unit that acquires device identification information identifying a heat cooking appliance and usage information obtained according to use of the heat cooking appliance, a tabulation unit that, for each store in which the heat cooking appliance corresponding to the device identification information acquired by the acquisition unit is installed, tabulates the usage information acquired by the acquisition unit, and a maintenance processor that, based on the tabulated results tabulated by the tabulation unit, generates a maintenance instruction maintaining the heat cooking appliance, and a terminal device that acquires the maintenance instruction generated by the maintenance processor and that outputs the acquired maintenance instruction to an output.

According to the above-noted constitution, because a heat cooking appliance maintenance instruction is generated based on the usage state of heat cooking appliances for each store, it is possible to reduce the deterioration of performance and failure of the heat cooking appliances.

A management system of an embodiment may have a management device that has an acquisition unit that acquires device identification information identifying a heat cooking appliance and usage information obtained according to use of the heat cooking appliance, a tabulation unit that, for each store in which the heat cooking appliance corresponding to the device identification information acquired by the acquisition unit is installed, tabulates the usage information acquired by the acquisition unit, and a food ingredient proposal unit that, based on the tabulated results tabulated by the tabulation unit, proposes food ingredients to be heat cooked by the heat cooking appliance and that transmits the proposed food ingredients to a server of a food ingredient developing vender.

According to the above-noted constitution, because cooking food ingredients to be heat cooked by a heat cooking appliance are proposed based on tabulated usage information, it is possible to provide products suitable to the heat cooking appliance and also to heat cook the food ingredients with good efficiency.

A management system of an embodiment has an acquisition unit that acquires device identification information that identifies a heat cooking appliance and usage information obtained according to use of the heat cooking appliance and a tabulation unit that, for each store in which the heat cooking appliance corresponding to the device identification information acquired by the acquisition unit is installed, tabulates the usage information acquired by the acquisition unit.

According to the above-noted constitution, it is possible to easily understand the usage state of each heat cooking appliance.

A management system according to an embodiment may have an acquisition unit that acquires device identification information identifying a heat cooking appliance and usage information obtained according to use of the heat cooking appliance, a tabulation unit that, for each store in which the heat cooking appliance corresponding to the device identification information acquired by the acquisition unit is installed, tabulates the usage information acquired by the acquisition unit, and a maintenance processor that, based on the tabulated results tabulated by the tabulation unit, generates a maintenance instruction that maintains the heat cooking appliances.

According to the above-noted constitution, because a heat cooking appliance maintenance instruction is generated based on the usage state of the heat cooking appliances for each store, it is possible to reduce the deterioration of performance and the failures of the heat cooking appliances.

A management device of an embodiment may have an acquisition unit that acquires device identification information identifying a heat cooking appliance and usage information obtained according to use of the heat cooking appliance, a tabulation unit that, for each store in which the heat cooking appliance corresponding to the device identification information acquired by the acquisition unit is installed, tabulates the usage information acquired by the acquisition unit, and a food ingredient proposal unit that, based on the tabulated results tabulated by the tabulation unit, proposes food ingredients to be heat cooked by the heat cooking appliance.

According to the above-noted constitution, because cooking food ingredients to be heat cooked by a heat cooking appliance are proposed based on tabulated usage information, it is possible to provide products suitable to the heat cooking appliance and also to heat cook the food ingredients with good efficiency.

A management method of an embodiment includes an acquisition step of management device acquiring device identification information that identifies a heat cooking appliance and usage information obtained according to use of the heat cooking appliance, a tabulation step of the management device, for every store in which the heat cooking appliance corresponding to the device identification information acquired by the acquisition step is installed, tabulating the usage information acquired by the acquisition step, and an output step of the terminal device acquiring the tabulated results tabulated by the tabulation step and outputting the acquired tabulated results to an output.

According to the above-noted constitution, the usage state of each heat cooking appliance can be easily grasped.

A management method of an embodiment includes an acquisition step of management device acquiring device identification information that identifies a heat cooking appliance and usage information that is obtained according to use of the heat cooking appliance, a tabulation step of the management device, for every store in which the heat cooking appliance corresponding to the device identification acquired by the acquisition step is installed, tabulating the usage information that has been acquired by the acquisition step, a maintenance processing step of the management device, based on the tabulated results that has been tabulated by the tabulation step, generating a maintenance instruction that maintains the heat cooking appliance, and an output step of the terminal device acquiring the maintenance instruction that has been generated by the maintenance processing step and outputting the acquired maintenance instruction to an output.

According to the above-noted constitution, because a heat cooking appliance maintenance instruction is generated base on the usage state of the heat cooking appliances for each store, it is possible to reduce the deterioration of performance and failures of the heat cooking appliances.

In a management method of an embodiment, a management device may include an acquisition step of acquiring device identification information that identifies a heat cooking appliance and usage information that is obtained according to use of the heat cooking appliance, a tabulation step of, for every store in which the heat cooking appliance corresponding to the device identification acquired by the acquisition step is installed, tabulating the usage information acquired by the acquisition step, and a food ingredient proposal step of, based on the tabulated results tabulated by the tabulation step, proposing food ingredients to be heat cooked by the heat cooking appliance and transmitting the proposed food ingredients to a server of a food ingredient developing vender.

According to the above-noted constitution, because cooking food ingredients for heat cooking according to a heat cooking appliance are proposed based on the tabulated usage information, it is possible to provide products that are suitable for the heat cooking appliance and also possible to cook the food ingredients by heat with good efficiency.

In a management system of an embodiment, a management device may have a store information storage that stores the device identification information in association and region identification information that identifies a region in which the store exists in which the heat cooking appliance corresponding to the device identification information is installed in association with each other, an acquisition unit that acquires device identification information that identifies a heat cooking appliance and usage information obtained according to use of the heat cooking appliance, and a tabulation unit that, for each region in which the heat cooking appliance corresponding to the device identification information acquired by the acquisition unit is installed, tabulates the usage information acquired by the acquisition unit, wherein the tabulation unit reads out from the store information storage the region identification information in association with the device identification information acquired by the acquisition unit and tabulates, for each region corresponding to the store identification information, the usage information.

In a management system of an embodiment, a management device may have an acquisition unit that acquires device identification information identifying a heat cooking appliance and usage information obtained according to use of the heat cooking appliance, a tabulation unit that, for each store or region in which the heat cooking appliance corresponding to the device identification information acquired by the acquisition unit is installed, tabulates the usage information obtained by the acquisition unit, and a proposal unit that, based on the tabulated results tabulated by the tabulation unit, proposes to heating condition (processing time) for food ingredients to be cooked by heat by a heat cooking appliance.

The usage information may include usage time of use of a heat cooking appliance in heat cooking and product identification information that identifies a product that has been cooked by heat, wherein the tabulation unit may, based on the usage time and the product identification information, tabulate the number of times of use of the heat cooking appliance corresponding to the product and a prescribed time of day, and the proposal unit may, based on the number of times of use of the heat cooking appliance corresponding to the product and the prescribed time of day, propose a heating condition (processing condition) for the food ingredient or the processed state of the food ingredient to be cooked by the heat cooking appliance and flavoring of the food ingredient to be cooked by the heat cooking appliance.

### INDUSTRIAL APPLICABILITY

An aspect of the present invention can be applied to management system or the like that is required to cook food ingredients by heating with good efficiency.

### DESCRIPTION OF THE REFERENCE SYMBOLS

1, 1a, 1b Management system
2, 2-1, 2-1 Store
3, 3-1, 3-2 Heat cooking appliance
4 Food ingredient producer
5 Server
10, 10a, 10b Management device
11, 11a, 11b Management storage
12, 12a, 12b Management controller
20 Store terminal
21 Display
30 Operating panel
31 Key input section
31A Cooking key
32 Liquid crystal display
33 Speech output
34 External interface
40 Heat cooking unit
41 Water supplying pump
42 Steam generating heater
43 Heater
44 Magnetron
45 Cooling fan
46 Water supplying pump
50 Storage
51 Setting information storage
52, 52a Usage information storage
60 Controller
111 Store setting storage
112 Store information storage
113, 113a Tabulated information storage
114 Shipping information storage
115 Maintenance information storage
116 Food ingredient information storage
121 Setting change processor
122 Usage information acquisition unit
123, 123a Usage information tabulation unit
124 Shipping processor
125 Maintenance processor
126 Food ingredient proposal unit

1. A management system comprising:
a management device that comprises:
an acquisition unit that acquires device identification information and usage information, the device identification information identifying a heat cooking appliance, the usage information being obtained according to usage of the heat cooking appliance; and
a tabulation unit that tabulates, for each store in which the heat cooking appliance corresponding to the device identification information that has been acquired by the acquisition unit is installed, the usage information having been acquired by the acquisition unit; and
a terminal device that acquires tabulated result tabulated by the tabulation unit, and outputs, to an output, the acquired tabulated result.

2. The management system according to claim 1,
wherein the management device comprises a shipping processor that, based on the tabulated result tabulated by the tabulation unit, creates a shipping proposal for food ingredient to be used in the heat cooking appliance, and
the terminal device acquires the shipping proposal for food ingredient created by the shipping processor and outputs, to the output, the acquired shipping proposal for food ingredient.

3. The management system according to claim 2,
wherein the usage information includes usage times and product identification information, the usage times being times at which the heat cooking appliance was used in heat cooking, the product identification information identifying a heat-cooked product,
the tabulation unit, based on the usage time and the product identification information, tabulates a number of times of use of the heat cooking appliance corresponding to the product and a prescribed time of day, for the each store, and
the shipping processor, based on the number of times of use of the heat cooking appliance corresponding to the product and the prescribed time of day, creates, for the each store, the shipping proposal for food ingredient corresponding to the product.

4. The management system according to claim 1, the management system comprising a store information storage that stores the device identification information and store identification information in association with each other, the store identification information identifying the store in which the heat cooking appliance corresponding to the device identification information is installed,
wherein the tabulation unit reads out from the store information storage the store identification information associated with the device identification information acquired by the acquisition unit and, for each store corresponding to the store identification information, tabulates the usage information.

5. The management system according to claim 1,
wherein the management device comprises a change processor that generates a setting key and a setting change instruction, the setting key being settable to heat cooking corresponding to a product to be heat-cooked in the heat cooking appliance, the setting change instruction changing the setting of heat cooking corresponding to the setting key, the generation being performed in accordance with a change of the product, and
the heat cooking appliance, based on the setting change instruction generated by the change processor, changes the setting of heat cooking corresponding to the setting key.

6. The management system according to claim 1,
wherein the management device comprises a food ingredient proposal unit that, based on the tabulated result tabulated by the tabulation unit, proposes food ingredient to be heat-cooked by the heat cooking appliance.

7. The management system according to claim 6,
wherein the food ingredient proposal unit, based on the tabulated result, proposes a half-cooked item that becomes a finished item by heat cooking by the heat cooking appliance.

8. The management system according to claim 6,
wherein the food ingredient proposal unit, based on the tabulated result, proposes food ingredient of a half-cooked item in accordance with the heat cooking setting set at a setting key to which heat cooking setting can be set in the heat cooking appliance.
